(19) United States
(12) Patent Application Publication
(10) Pub. No.: US 2008/0189240 A1
(43) Pub. Date: Aug. 7, 2008

(54) System, method and software for creating or maintaining local or distributed mapping and transparent persistence of complex data objects and their data relationships

(76) Inventors: Ward R. Mullins, San Francisco, CA (US); Alexandre J. Martins, Florianopolis (BR)

Correspondence Address: J G Mullins, Suite 304, 1618 East Gate Way, Pleasanton, CA, 94566, US

(21) Appl. No.: 11/702,955

(22) Filed: Feb. 5, 2007

(51) Int. Cl. G06F 17/30

(52) U.S. Cl. 707/2

(57) ABSTRACT

The invention provides computer systems, computer data stores and methods and software for accessing and utilizing data stores. More particularly, the present invention provides systems, methods and software for creating or maintaining local or distributed mapping and optional transparent persistence of data objects, objects for stored procedures, complex data objects, data object graphs and associated data stores. The present invention further provides a computer system and software implemented method for a development mapping workspace for improved project management of mapping and persistence development activities along with a system implemented organization of mapping projects. In another aspect, the invention provides a computer system and software implemented methods for automatically mapping objects to one or more data source with an interface for setting variable stringency for such automatic mapping with an optional interface for editing the resulting system generated mapping, which system and software implemented methods may be collectively referred to as a “magic mapper” system. Further, such systems and software implemented methods are optionally integrated with IDEs, case tools and other third party platform or development environments to provide an extension of functionality or alternative functionality to such IDEs, third party platforms and other development environments, and to optionally provide for improved automatic or semi-automatic logic code generation.

### COPYRIGHT NOTICE

A portion of the disclosure of this patent document contains material which is subject to copyright protection. The copyright owner has no objection to the xeroxographic reproduction by anyone of the patent document or the patent disclosure in exactly the form it appears in the Patent and Trademark Office patent file or records, but otherwise reserves all copyright rights whatsoever.

### FIELD OF THE INVENTION

The field of the present invention relates generally to computer systems, computer data stores and to methods and software for accessing and utilizing data stores. More particularly, the present invention relates to system, methods and software for creating or maintaining local or distributed mapping and optional transparent persistence of data objects, objects for stored procedures, complex data objects, data object graphs and associated data stores. In one aspect, the invention also relates to a computer system and software implemented method providing a development mapping workspace for project management of mapping and persistence development activities along with a system implemented organization of mapping projects. In another aspect, the invention is related to a computer system and software implemented methods for automatically mapping objects to one or more data source with an interface for setting variable stringency for such automatic mapping with an optional interface for editing the resulting system generated mapping, which system and software implemented methods may be collectively referred to as a “magic mapper” system. Further, such systems and software implemented methods are optionally integrated with IDEs, case tools and other third party platform or development environments to provide an extension of functionality or alternative functionality to such IDEs, third party platforms and other development environments The above systems can provide for smooth integration of object to data source mapping development (particularly object to relational mapping development) with code generation, and provide for automatic or developer controlled code generation with increased manageability of such code generation. By utilizing the above system, virtually any java object, object graph, or data source can be mapped and transparently persisted. Further, copies of a data graph, stored procedures, or a portion of the data graph can be automatically reconciled and changes persisted without any persistence coding in the object model.

### BACKGROUND OF THE INVENTION

Systems for accessing data stores from object oriented languages have been used for many years. A frequent approach to accomplish access of data stores involves writing and embedding custom access code within an object application needing the access. This approach is generally limited to having the custom code access only a single relational table within a relational database or similar construct within any other data store (hereinafter collectively “data store”). Under the circumstances where a developer has control over the design and creation of a data store from its inception, it is possible to design and store meaningful information in a single table. Such design opportunities are usually rare, however.

Generally, the methods for producing persistence for a data object, complex data object or a data store conflict with the goals of producing pure object application models where the object models do not include persistence objects or persistence byte code. Particular difficulties exist in a distributed environment since an object application model or an unmodeled group of related objects may exist in one or more of a computer's memory, an application data store or in an application information storage repository that may be independent of the data store organization or object definitions. Advancements in the art have been made with respect to tools for conveniently mapping objects to systems of tables and maps in order to expedite accessing, changing and updating data stores. See, for example, U.S. Pat. No. 5,857,197 (and its associated programming interfaces (“APIs”)) which describes tools for translating object data to relational data, relational data to object data, and object data to object data to expedite the use of data stores. The BMP and the CMP Installer portions, and complex persistent objects of the CocoAdmin tool in the CocoBase™ Enterprise for O/R Binary Software (Thought, Inc. 657 Mission Street Suite 202, San Francisco, Calif. 94105 http://www.thoughtinc.com,) provide a convenient means for providing persistence in EJB or in environments utilizing other complex objects (composite object-like components).

Persistence problems arise with the creation, access, changing or deleting of an object application model that utilizes such data stores. There did not exist, prior to this invention, an automatic mapping facility with automatic mapping stringency that can be controlled by settings from the end user for automatically mapping a group of objects and logically deducing their relationships to one another to automatically produce an editable complex data object graph, and to also map the relationships of such objects to a data source, such as a relational data source. Moreover, there did not exist software logic or a system that would permit global update, delete, or insert functions as a batch object, particularly when the data being processed may span multiple logical object instance models. This becomes particularly complicated when the object application model having data that needs to be persisted may be distributed over multiple physical computer machine locations or even distributed over multiple Internet website locations that may be independent of the data stores. The object application model may utilize a different set of data objects or different set of definitions for relationships between data objects than that of one or more of its data sources. In most situations, the respective structures of the data sources and of the object applications model simply do not conveniently allow for mapping, accessing or changing of an overall schema of application data objects as well as any associated definitions of relationships between two or more data objects or elements within a data object. Batch update, delete and insert operations in such a system have simply not been possible.

Importantly, relationships may exist between a data object and one or more of the other data objects found in the object application model or in a data object of the data source. A relationship between one data object and another data object or with a data source may be member selected from the group of three relationship types consisting of 1 to 1 (1-1), 1 to many (1-M) or many to many (M-M). Complex combinations of these relationships may exist as a data object relationships definition for a given data object. These relationships are described or illustrated in further detail later in this document.

Objects may logically span multiple relational tables or multiple object databases, and may even be distributed over a logical (or hypothetical) computer system involving multiple physically independent computer systems or even multiple website locations. Creating, accessing, maintaining or updating an object application model can require working with multiple translation modules and require tedious and repetitive updating of multiple individual computer systems or multiple data sources in order to do useful work and keep the object application model synchronized. Such approaches are both costly and unwieldy in terms of computing and development resources, particularly with respect to Internet based electronic commerce (eCommerce) object application models. There is a need for a persistence application and computer system that will permit true global update, insert and update batch operations where the batch operations is compatible with both the applications that process and use data and the data stores to which data and object models need to be persisted.

Data objects of an object application model are often a feature of eCommerce object programming applications, where information is obtained from a data source and the data is defined as a data object (e.g., as a Java class) for use with another computer application. In practice, a data object or model of data objects may exist only in the random access memory of a computer memory system, or may be saved to either a data source or to some other type of retrievable information repository. Such informational repositories are of often referred to as “data pools” within application servers, which are effectively a simple reorganization of data retrieved from one or more external object or relational data sources by the application server where data is processed and relocated by the application server into a temporary object data source within the application server itself. Such data pools exist independently of the external data sources and are accessed directly by one or more users of the application server. No logic exists within such application server systems for directly persisting object models of the applications being utilized within the data server to one or more data source at the same time as the data is being persisted. There is no attempt to have a system with an independent mapping layer external to the application server where the schema of the applications and the schema of the data sources are mapped and mismatches are resolved. Instead high-level programmers that manage application server data pools must provide and update the internal mapping of data objects to object applications running in the server (provide logical “data buckets” or updated cross-reference tables) so that regular users and access and use the temporary object data source “data pools” within the application server without any need for understanding the mapping of those data objects to the data source that will permit updating of one or more external data source(s) when data objects are changed within the data pools that are located within the application servers.

In the above system that utilizes internal application server data objects located in an internal object data source data pool, programmers that maintain the application servers and their temporary internal data pools are forced to develop and maintain a mapping layer that is external to the application servers in order to handle changes to the data within the data pools or are required to set up restrictions on how applications within the application server may use data from the data pools in order to avoid the need for external mapping. Such as system to shield application users from external and internal mapping of objects to the schema of one or more data sources creates limitations in how data may be used by applications running within the server and also slows the application server system by creating overhead for the application servers that is required to manage the flow and the use of data within data pools located within the server.

In such an internal application server data pool system, programmers must often develop and maintain high level data object “buckets” that exist within the application server between the data pools and the external data source(s) that will work with the application server's proprietary version of a JDBC data source driver and are designed to side-step the use of a regular JDBC driver provided for the one or more external data source(s) by their vendors in order to permit users to utilize object data within the “data pools” in a way that permits proper updating of the external data source(s) through the proprietary version of a JDBC data source driver. Often the data pools also contain stored object queries that have been pre-translated into SQL statements that will retrieve the data from the data source and serve it up to applications running within the application server in pre-designed data buckets that are located within the data pool where the pre-designed data buckets are designed by high-level programmers who understand both SQL and JDBC drivers and write the stored procedure queries.

Although some literature may confusingly refer to such “data pools” as a “repository” this is a misnomer since a data pool is not an external repository, but is actually an object data source of data objects that exists within the application server environment itself. This is not to be confused with middleware mapping software that may contain one or more repositories of mapping logic capable of mapping to and from object to relational, object to object, relational to XML, or object to XML and logic for such an external mapping layer that can automatically map and persist object schema of the data source to an object application where the objection can either run solo or run within an application server. Such an external mapping layer may not only contain the logic to handle the generation and persistence of maps, but it also may contain the logic to directly access the data source through a JDBC driver and obtain the schema of the data source and but the logic to persist, such a mapping layer may contain the logic to generate SQL and utilize stored queries from either multiple applications, multiple application servers or both independently of the application server and its data pools. Thus, such middleware software includes a mapping layer that exists between the application server and one or more data sources and can directly handle requests from applications running within one or more application servers for data from the data sources and the external mapping layer may handle multiple servers that utilize the same or different data source(s).

Such an independent mapping layer with an external data source is quite readily distinguished from an internal object data source data pool, since such approaches are logically unrelated and are of a different architecture. Moreover, having an external data source with the ability to map and persist both application object schema and data source schema while resolving mismatches is important since a programmer or administrator of an object data application cannot easily access or track the overall model or diagram of data objects for an object application model or some of its specific elements. Unfortunately, tools for accessing and persisting data objects and associated data object relationships of a complex data object graph model have not been well implemented in the field of object language programming. Even more importantly, no such system has included the logic to order and arrange data source accessing, object and data modeling and persisting of both to a data source as a batch process compatible with data restrictions of individual data sources that may be utilized by object applications

A computer application can execute one or more of the following non-limiting actions with respect to one or more of the members selected from the group consisting of data, a data object, and a data object definition: access data, change data, create data, create a new relationship between one or more data objects by creating or changing at least one data object relationship definition, change or delete a relationship between one or more data objects by changing or deleting at least one data object relationship definition, access a data object relationship definition and use its parameters to access a data source or a data object, and access one or more data object relationship definitions or data objects to create a new data object or data object relationship. Any changes executed by a computer application with respect to one or more of the members selected from the group consisting of data, data object or data object definition may need to be properly persisted (permanently stored) to preserve any changes to one or more of the members selected from the group consisting of data, a data object and a data object definition. Prior to the present application, it was simply not possible to execute such actions as a true batch process, since data within an object model may exist with dependant relationships such as parent/child and data cannot be stored in a child object until after the parent is created, for example. Trying to manually decide the order of inserting, deleting and updating required a programmer to not only understand object relationships, but also understand data source restrictions and manually create a script to provide for batching to occur. Prior to the present invention, there was no software or system in existence that could utilize the data relationships from one or more object models and the data relationships within one or more data sources to automatically parse data inserts, updates and deletes to provide a true batch without the user needing to understand the relationships of the object schema to the data source schema.

A data object and an associated data object relationship definition may be represented by a complex data object graph (“CDOG”). A CDOG, for the purposes of this document, may be thought of as a computer program data object graph that represents a data object having at least one relationship with at least one other data object or with itself via a circular link. When the data object of a CDOG is implemented in the Java computer program language, the CDOG may be further defined as being a Java Data Object Graph (“JDOG”).

There are needs for software, methods and systems that can more easily detect and persist any changes to at least one member selected from the group consisting of a data object, any data associated with the related object, or any associated CDOG definition (i.e., an changes to the data object, data or to a relationship of the data object with another data object). In particular, there is a need for such software, methods and systems that can parse such changes and provide a true batch process to store such changes that is compatible with underlying data sources. For example, there is a need to be able access a pure object model definition from a repository based O/R mapping tool file or from a modeling tool repository file and provide persistence for the object model without inserting any byte code or additional objects into the object model, and to be able to do so for individual objects or as a batch process.

Accordingly, there is a strong need in the art for a computer applications programmer tool designed to assist a programmer or administrator in the actions of providing persistence for data objects or data object graphs when deleting, inactivating or updating a CDOG, wherein the computer applications programmer tool can be configured to automatically reconcile all or a portion of a CDOG and copies thereof on a distributed environment when data objects or relationships are deleted, inactivated or updated for a CDOG. A particularly strong need exists for such a tool having the further ability to be configured to persist, propagate and reflect system wide (in a local or distributed computer system) any such changes to a CDOG instance to all instances of the CDOG and to all instances of associated data, data objects and data object relationships. Moreover, there is a need for such a system and software that can parse changes and thus provide true batch storage of changes without requiring the end user to understand object application schema or data source schema.

### Definitions

The following non-exhaustive list of definitions is used herein to define terms that may otherwise be confusing or can sometimes have multiple meanings. Each occurrence of a defined term in the above text, in the text that follows, or in the claims of this document, is to be given the meaning ascribed to it in the list of definitions below.

“Instance” as referred to in this document in the context of computer software applications is a single occurrence of a software logical element in the memory of a computer system, such as a “class”, an “object”, a “data object”, and the like.

“Class” as referred to in this document in the context of computer software applications is a logic unit in a computer application or a computer software program where the application or program is based upon an objected oriented programming language (e.g., Java). In practice, a class is a logical unit used as a logical template in an object oriented language from which to allocate new instances of objects.

“Object” as used in the context of this document is a general term referring to a logic unit in a computer application or a computer software program where the application or program is based upon an objected oriented programming language (e.g., Java). The term “object” may ordinarily be used interchangeably with the term “class” as a template or as an instance depending on the context.

“Data object” as referred to in the context of this document represents the concept of the occurrence of an object that holds data within a specific computer application domain and is likely to have its contents stored in a persistent data source of a computer system (e.g., a database server, a binary file, a text file, or even in a combination of two or more of such a persistent data sources of a computer system). A data object may exist as an independent data object without any relationship to any other data object or it may have one or more relationships with itself or with one or more other data objects.

“Complex data object” (or “CDO”) as used in the context of this document refers to the occurrence of a data object that has at least one or more relationships with itself, or at least one or more relationships with one or more other data object(s). In a given instance of a CDO at least one relationship is populated as a link, as defined below. A CDO may have a multiplicity of different relationships with itself or with one or more additional CDOs.

“Relationship” or “data relationship” as used in the context of a CDO refers to the type of logical combination that occurs between a data object with itself, or refers to the type of logical combination that occurs between a data object and at least one another data object. Among other references or descriptions, such a relationship is always referred to or partially described by a “relationship type”. This term is used in an object oriented language context to reference or describe any expectations, actions and limitations possible between two or more data objects.

“Relationship type” in the context of this document is a label that specifies the possible multiple combinations that can occur between a CDO and itself or with at least one other CDO. The possible relationship type labels are 1-1 (one to one), 1-M (one to many) and M-M (many to many). A given CDO may be simultaneously related to more than one other CDO through several different types of relationship.

“Link” as used in this document with respect to a CDO identifies a particular occurrence of a relationship between a CDO and itself, between a CDO and another CDO. The occurrence of at least one populated link results in an instance of the CDO.

“Circular link” as used in this document with respect to a CDO identifies a particular occurrence of a relationship between a CDO and itself that may be direct or indirect (e.g., linked to itself through another CDO).

“Relationship definition” or “relationship description” in the context of this document and computer software applications refers to information, or an abstraction of information, regarding a “relationship”, “data relationship” “relationship type” or a “link” that can be stored, accessed, transferred, communicated, displayed or edited.

“Complex data object graph” or “CDOG” is a term employed herein as an abstraction to logically represent a set of complex data objects and a set of their corresponding relationships.

“Java data object graph” or “JDOG” is a term employed herein as an abstraction to logically represent a set of complex data objects and a set of their corresponding relationships that are part of a Java programming application.

“Application model” or simply “model” are essentially interchangeable terms employed herein as abstractions to logically convey a collective description or other representation for a set of complex data objects and a corresponding description or other representation of their relationships. In one respect, these terms are used logically herein provide a general way of efficiently communicating when referring to set of metadata (i.e., data about data) that describes possible data entities (e.g., objects, database tables, maps, etc,) data relationship types, and data constraints involved in a computer system or application, or in a specific instance of an application. It is important to understand the context in which the terms “application model” and “model” are used in this document. Ordinarily computer engineers refer to the “model” as an abstraction rather than a specific possibility or instance of the model as applied. However, in this document for the ease of communication abstractions of the model, possible implementations of the model and instances of the model are all referred to generally as “application model” or “model”. From the context of its use the term will be clear.

“Navigation”, “navigating” or “navigated” in the context of the present document refers to an action implementing at least one object to interact with a set of related objects for a certain purpose, such as creation, access, insertion, modification and deletion of an object, or of one of its relationships.

“Navigation model” as used herein is a special type of application model that is applied specifically to a description (or other representation) of how objects can relate to each other and what might be the expected behavior when a CDOG is navigated for a certain purpose.

“Object schema” is a term employed herein as an abstraction referring to the set of data object classes that describe the possible data objects that can be created, modified or maintained in an application, or describing an instance of a set of data object classes in an application.

“Distributed Transparent Persistence” is a term employed herein as an abstraction referring to the concept of providing persistence for a member selected from the group consisting of a data object, a data object graph, associated data and data object relationships in a distributed environment without the need for the insertion of byte code or data objects in an object model or schema.

“CocoBase Proxy Classes” is a term employed herein used in referring to wrapper classes that provide CocoBase runtime compatibility for objects that aren't inherently database aware. A computer system can persist the attributes and data for any data object that is wrapped with a CocoProxy wrapper class by simply using CocoBase facilities. For example, source code for the (attribute based) CocoProxy and (get/set method based) CocoProxyM classes are available under the thought\cocodemo3tier31\demos\pguide directory, when the CocoBase software tools suite is installed on a computer system.

“CocoBase Navigation API” is a term employed herein to refer to an example of an API that provides database relationship mapping and object graph management capability for persistent objects. Database relationships are mapped to object links using CocoBase Navigator link definitions. Persistence control is provided at each class level in the object graph. Each of the Select, Insert, Update and Delete operations are individually configurable.

“CocoBase Transaction API” is a term employed herein to refer to an example of an API that provides object oriented transaction support. Transaction objects are used to persist data object attributes and maintain synchronization between database and in memory attribute values. The Transaction API has many built in optimizations, and applications utilizing CocoBase transactions generally benefit from reduced database and network overhead.

“CocoBase Factories” is a term employed herein to refer to examples of software modules and software libraries that are used to provide automated, custom object instantiation behavior. Factory behavior is completely customizable. For example, a factory may be used to bind newly instantiated objects to a transaction object, to load a graph of related objects using the CocoBase Navigator, or to implement polymorphism in a database result set. For example, a ProxyFactory class is part of the current CocoBase software tools suite distribution in the thought\cocodemo3tier31\demos\pguide directory, and this factory returns result set objects wrapped in a CocoProxy wrapper, when a CocoProxy wrapped key object is passed into the CocoBase runtime software module as part of a query that needs processing by the CocoBase runtime module.

“CocoBase Repository” is a term employed herein as an abstraction referring to a data source to data object mapping repository and associated software modules that is installed into a data source (or may optionally be a single stand alone file, or a set of files that circumscribe a set of data source to data object mapping definitions and associated software modules). A repository can optionally be in a format such as XML, XMI and the like. See, U.S. Pat. No. 5,857,197, the CocoBaseEnterprise O/R Tools Suite, and the co-pending patent application entitled “Dynamic Object-Driven Database Manipulation and Mapping System” for more detailed descriptions of mapping repositories, and the like.

“CocoBase Transparent Persistence for Objects and Object Models”. All models using a relational database for map storage require the CocoBase repository to be installed into the database, or in a stand-alone source accessible to CocoBase. The installation of a mapping repository can occur automatically, if required, when using CocoAdmin to log into the database. Pre-existing database tables can be used, provided that the CocoBase repository is first installed into the database, or accessible to CocoBase. Several examples of applications that implement CocoBase transparent persistence are included in the CocoBase software tools suite distribution under the demos\pguide\navapi and demos\pguide\transpersist directories.

“Data Object Pool or Pools” is a term employed herein to refer to an object data source, data tables and schema that are located internally within an application server. Sometimes data object pool or pools refers to virtual data objects, which when present are composite and highly structured data objects that exclusive to the server environment and often require maintenance when any underlying data structures or object applications are changed. Even if data pools are sometimes mistakenly referred to in the literature as a “repository” this is not a middleware external mapping repository as is defined in object to relational middleware or similar applications. Data object pools may optionally contain data object buckets that are written or managed by application server programmers and that utilize proprietary JDBC drivers in order to shield application users of applications running within the server (such data object buckets systems can also include one or more highly structured and generally inflexible composite virtual data object(s)). The application server itself still needs to access external software modules and software libraries from an object to data source mapping repository or provide data buckets that are managed by the application server and that are used to provide automated, custom object instantiation behavior.

“CDOG Batch Persistence” or “Complex Data Object Persistence” is a term employed herein that refers to the event or process of utilizing software logic to analyze one or more sets of data objects and their relationships (i.e., analyzing a CDOG), analyzing the data storage schema of at least one underlying data source, generating a batch script that is based upon the analyzed structures of both CDOG(s) and data source(s) that will permit a truly automated batch persistence of both data and their relationships as a CDOG, and executing the script to implement batch persistence storage of inserted, updated or deleted data objects, data relationships or both data objects and data relationships as a CDOG. Such a process automatically parses data inserts, deletes and updates to provide a true batch process without the user needing to understand the relationships of one or more object schema(s) to one or more data schema(s) of one or more data sources. Such persistence can bridge multiple data sources, multiple networks, and multiple users or user groups to provided distributed CDOG Batch Persistence in a seamless manner with ease of use for the end user.

“Magic Mapper System” or “MMS” is a term employed herein in referring to a computer system and software implemented methods for automatically mapping objects to one or more data source with an interface for setting variable stringency for such automatic mapping and with an optional interface for editing the resulting system generated mapping, which system and software implemented methods may be collectively referred to as a “magic mapper” system. In a preferred embodiment, the system generated mapping provides one or more XML files that can be edited to fine tune, to change, or to add or delete objects, mapping relationships, or both.

A “project” as used in the context of this application is a namespace where abstract class mappings are defined such that each class mapping has a unique name. Each class mapping or dot net component mapping references a possibly existing Java class or a dot net component, meaning that mapping is done at an abstract level. A class mapping or component mapping becomes concrete when it is bound with a specified class instance or component instance at runtime. In typical usage, for example, only one class mapping is defined for each Java class within the context of a project. In advanced scenarios, a single object instance can be referenced by several class mappings. Applications can also be configured to load multiple project definitions simultaneously, allowing multiple mapping sets for a single set of Java classes.

A “class mapping” or “dot net component mapping” is a logical mapping entity that describes class level or component level persistence requirements. It contains meta-information pertaining to class or component structure and describes attribute persistence behavior, class or component inheritance structure and propagation of persistence functionality through class or component relationships. Since a class mapping or component mapping definition is bound to an object at runtime, it remains an abstraction until the specified class or component instance is loaded from the runtime classpath. A class mapping or component mapping is comprised of a set of mapping elements, each associated with a persistent class or component member. Examples of valid member types are data attribute, relationship link, composite members and the like.

A “SQL map” is a physical implementation of a class or dot net component mapping definition that generically specifies how class or component data maps to database tables. It is an abstract representation of SQL operations that are generated by the mapping layer. No classname references exist within a SQL map. Instead, a SQL map is associated with a Java class or dot net component through a class mapping or component mapping definition. A SQL map can be freely associated with different Java classes or dot net components provided each class or component defines a compatible shape for persistence. A SQL map also provides a physical entry point for SQL customization. SQL maps provide the ability to intercept and modify the baseline SQL that is generated by the mapping layer when there is a requirement tune and optimize the SQL. Additionally, when compared to relational database modeling features, a SQL map can be defined as a shared updatable SQL view, defined on the application client side (rather than on the database server side), and thus being reusable across databases.

A “procedure map” as used herein is a physical map implementation that generically specifies how data fields map to a database procedure or function call. A procedure map is an abstract representation of the JDBC call produced by the mapping layer, when invoking database stored procedures. Unlike a SQL map, a procedure map cannot generated from a class mapping or component mapping definition. Instead, class fields or component fields must be mapped using the CocoBase Workbench or by editing a stored procedure map directly. In procedure routing strategies, a procedure map can be used as a target for operations defined in a SQL map. Whenever a SQL operation is invoked for an object, the configured procedure map would be called in place of the corresponding SQL statement for that operation.

A “mapping project workspace” or “workspace” as used herein refers to a system location, such as a folder containing at least two decoupled elements or access to at least two decoupled sets of mete data as workspace elements wherein one the sets of metadata corresponds to meta data for an object application logic program and the other set corresponds to the meta data for at least one data source and the workspace utilizes computer implemented methods for creating or maintaining mapping for object to object, object to relational or object to XML and optional transparent batch persistence of a complex data object, a complex data object graph model, or a portion of a complex data object graph, or of stored procedures without the end user being required to understand the underlying object schemas, underlying data source schemas, or relationships and mismatches of both the underlying object schemas and underlying data source schemas.

### SUMMARY OF THE INVENTION

An object of the present invention is to provide an object to object application or object to data source mapping system that utilizes a mapping workspace comprising a computer system and computer implemented methods for creating or maintaining mapping for object to object, object to relational or object to XML and optional transparent batch persistence of a complex data object, a complex data object graph (CDOG) model, or a portion of a CDOG without the end user being required to understand the underlying object schemas, underlying data source schemas, or relationships and mismatches of both the underlying object schemas and underlying data source schemas. In a preferred embodiment, an object of the present invention is to provide such a system that can selectively persist all or a portion of a CDOG model as a true batch process when the model is a member selected from the group consisting of an object model generated from a data object mapping repository and an object model generated from data object modeling tool repository. A further object is to provide such a system is located on, or is part of, a local or distributed computer system.

An object of the present invention is to provide a computer system and software implemented methods for automatically mapping objects to one or more object models, to one or more data sources, or both with an interface for setting mapping variables logic stringency for such automatic mapping and further including an optional interface for editing the resulting system generated mapping, which system and software implemented methods may be collectively referred to as a “magic mapper” system. In a preferred aspect, an object of the invention is to provides such a magic mapper system that generates mapping output as one or more XML files that can be edited to fine tune, to change, or to add or delete objects, mapping relationships, or both.

Another object of the invention is to provide an open and extensible mapping, business logic, and stored procedures repository structure that provides independence from how the mapping of object to object model, object to logic, or object to data source mapping metadata is stored or managed internally by the mapping system and allows standards compatibility with possible user customization and extensibility.

Still another object of the present invention is to provide a system and computer implemented methods designed for static and deferred SQL map generation, such that static compilation of SQL logic at runtime permits a developer to interfere or manipulate the SQL used at runtime, while dynamic compilation permits the developer to avoid having to deal with details on how SQL is generated. This provides a flexible system where the deferred SQL map generation option provides a more portable solution for object to application or object to data source (particularly O/R) mapping as opposed to the static option which allows for a more specific/optimized/tuned solution that may also require more sophisticated maintenance to stay specific/optimized/tuned when changes are made to the system, system environment, or system logic.

A yet further object of the present invention is to provide integration of the above objects (mapping workspace, magic mapper, open repository architecture and static or deferred mapping option) with one or more third party IDEs, case tools, or development platforms as an extension or replacement component for such IDEs, case tools, or development platforms by integration of some or all of the above functionality into the third party platform or development environment so that the developer can have it as an add on to their development environment and into their development process.

A still further object of the invention is to provide integration of the above systems and computer implemented logic with automatic, tunable, extensible, or managed code generation facilities to provide better code generation and manageability between the O/R, object to object application, or other object to data source mapping and subsequent code generation output in an automatic or semi-automatic manner as a consequence of using the systems and computer implemented objects of the invention as described above.

Another object of the present invention is to provide such a system and computer implemented methods comprising a computer software component similar to a complex object that operates in an EJB environment, dot net, or the like, wherein the component has the capacity to access an object model repository or an instance thereof in a computer memory or in another temporary computer storage store device and persist multiple actions selected from the group consisting of creating, maintaining, accessing, navigating, updating or deleting complex data objects as a CDOG model as a true batch persistence process that is compatible with both the EJB environment and the structure of one or more underlying data source(s). In a preferred aspect, the computer software component comprises an Enterprise Bean or dot net component selected from the group consisting of Stateless, Stateful and Entity Beans or one of their dot net analog complex objects that coordinates with logic for ordering and parsing persistence of data in such a way that true batch persistence of both data objects and their relationships are persisted as a CDOG. In a further preferred object the computer software component is an EJB Session Bean or dot net equivalent that is built on top of CocoBase runtime libraries or runtime dot net components having the ability to persist all or a portion of a CDOG model or instance thereof as a true batch process. An even more preferred object is to provide such a computer software component capable of transparently persisting all or a portion of a CDOG model or instance thereof for a local or distributed computer system and automatically reconciling and persisting any changes to an instance of the CDOG model or any changes to the repository definition for the CDOG model as a batch process that takes into consideration relationships between data objects, such as parent/child, 1 to 1, 1 to many, and many to many such that dependent operations are executed after a necessary first operation. For example, parent persistence occurs before child persistence or parent objects and relationships are created, inserted, deleted or updated, before child objects and relationships are created, deleted inserted or updated.

A preferred object of the present invention is to provide a software tool comprising the a navigation API and software component (as described above), adapted for a local network or a distributed network environment, wherein said software tool provides persistence transparently in an object oriented language environment (such as Java, C sharp, or dot net) by implementing a configurable network component capable of acquiring and persisting CDOGs or analogous dot net components through network APIs. A further object is a software tool associated with such an API, wherein the software analyzes persistence needs of a system to determine schema relationships in the application and cross-reference such relationships and data with the schema relationships and data in the underlying data source to permit parsing of persistence such that a true batch CDOG or equivalent dot net component persistence process can be executed, and executing such a process.

A further object of the present invention is to a software tool capable of reading a source programming object logic model or a database file in a format selected from the group consisting of a UML data file, a XMI data file, and a XML file and converting the information into a target member selected from the group consisting of a database definition XML file, a database mapping definition file, and a CDOG definition file. In a preferred object, the software can automatically generate a transparent persistence layer that corresponds to the object model information of the source file.

A further object of the present invention is to provide a software module and source code known as a an Java entity bean (such as a generic session bean) or an equivalent dot net component that is capable of providing persistence of either or both of a data objects and a data model, in total or in part as determined through setting established by a user of the computer system, wherein the Java entity bean or dot net component is associated with one or more additional software module(s) and logic for ordering of the CDOG or equivalent dot net component to provide a true CDOG or equivalent dot net batch persistence capability of the software system.

### BRIEF DESCRIPTION OF THE DRAWINGS

For the non-limiting purpose of illustrating some of the concepts of complex data objects CDOs, i.e., data objects and their relationships to one another, according to the invention, two CDO graph drawings FIG. 1 and FIG. 2 are provided.

FIG. 1 is a complex data object (CDO) graph drawing, which illustrates a customer object and some of its related objects (billing address, orders and items ordered), as well as relationships between the objects. Relationships of the types 1 to 1 (1-1) and 1 to many (1-M) are shown in this CDO graph. More specifically, FIG. 1 illustrates a CDO graph drawing presenting an instance of a customer object 1 having a 1 to 1 (1-1) relationship (5) with its customer billing address object 10, and a 1 to many relationship (collectively 15, 25, and 35) with the three outstanding order objects 20, 30 and 40, respectively. Order object 20 is an instance of an outstanding order object having a 1 to many relationship (collectively 45 and 55) with the two items ordered objects 50 and 60, respectively. Order object 30 is an instance of an outstanding order object having a relationship with a single order item, but order object 30 has a 1 to many relationship (65) with the item ordered object 70, since many order items could have been associated. Order object 40 is an instance illustrates a 1 to many relationship (collectively 75 and 85) with the two items ordered objects 80 and 90, respectively.

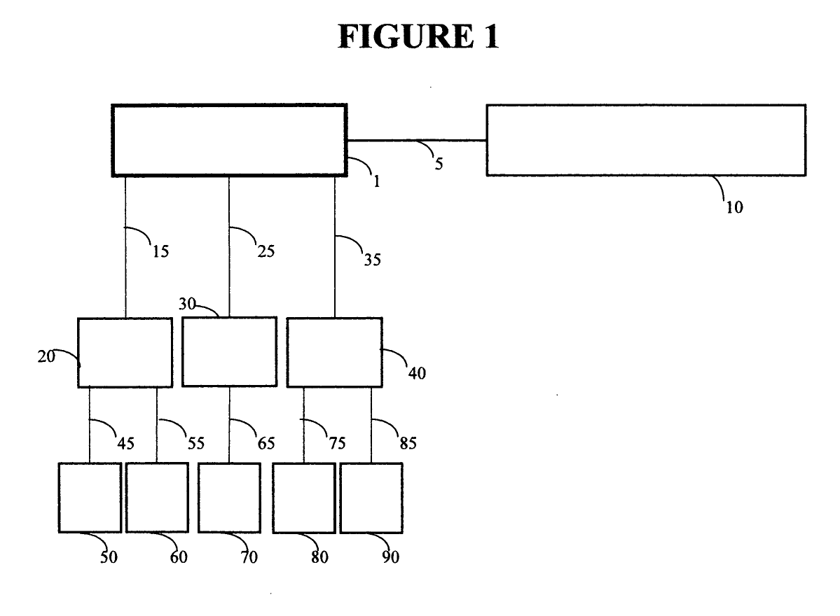

FIG. 2 is a complex data object (CDO) graph drawing, which illustrates a company object and some of its related objects (corporate address object and some of its departments and employees), as well as relationships between the objects. Relationships of all three types: 1 to 1 (1-1), 1 to many (1-M) and many to many (M-M) are shown in this CDO graph. More specifically, FIG. 2 illustrates a CDO graph drawing presenting an instance of a company object 100 having a 1 to 1 relationship (650) with its corporate address object 700, and a 1 to many relationship (collectively 150, 250, and 350) with the three company department objects 200, 300 and 400, respectively. Since employees of this company may work for more than one of the company's departments, the company department objects 200, 300 and 400 in FIG. 2 are three instances (many) of company department objects having relationships (425, 450, 550 and 575, respectively) with two (many) employee objects (respectively, 500 and 600). The cross-assignment of employee object 500 to both company department objects 200 and 300, and of employee object 600 to both company department objects 300 and 400, illustrate a complex many to many (M-M) relationship of departments to employees for this company.

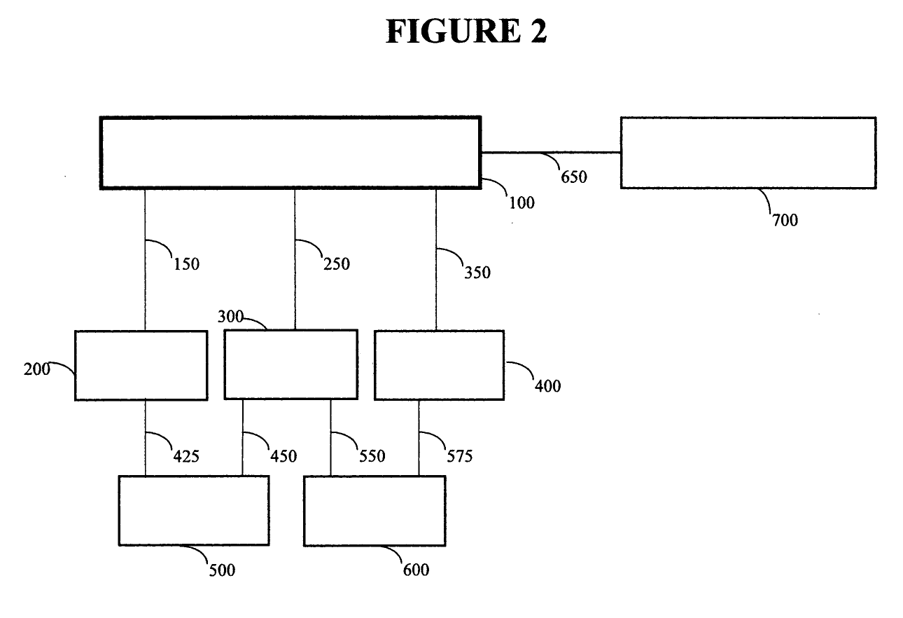

### DESCRIPTION THE INVENTION

The present invention provides an object to object application or object to data source mapping system that utilizes a mapping workspace comprising a computer system and computer implemented methods for creating or maintaining mapping for object to object, object to relational or object to XML and optional transparent batch persistence of a complex data object, a complex data object graph (CDOG) model, or a portion of a CDOG without the end user being required to understand the underlying object schemas, underlying data source schemas, or relationships and mismatches of both the underlying object schemas and underlying data source schemas. In a preferred embodiment, the present invention provides such a system that can selectively persist all or a portion of a CDOG model as a true batch process when the model is a member selected from the group consisting of an object model generated from a data object mapping repository and an object model generated from data object modeling tool repository. A preferred embodiment provides is an embodiment wherein such a system is located on, or is part of, a local or distributed computer system.

An embodiment of the present invention provides a computer system and software implemented methods for automatically mapping objects to one or more object models, to one or more data sources, or both with an interface for setting mapping variables logic stringency for such automatic mapping and further including an optional interface for editing the resulting system generated mapping, which system and software implemented methods may be collectively referred to as a “magic mapper” system. In a preferred aspect, one embodiment of the invention provides such a magic mapper system that generates mapping output as one or more XML files that can be edited to fine tune, to change, or to add or delete objects, mapping relationships, or both.

Another embodiment of the invention provides an open and extensible mapping, business logic, and stored procedures repository structure that provides independence from how the mapping of object to object model, object to logic, or object to data source mapping metadata is stored or managed internally by the mapping system and allows standards compatibility with possible user customization and extensibility.

Still another embodiment of the present invention provides a system and computer implemented methods designed for static and deferred SQL map generation, such that static compilation of SQL logic at runtime permits a developer to interfere or manipulate the SQL used at runtime, while dynamic compilation permits the developer to avoid having to deal with details on how SQL is generated. This embodiment of the invention provides a flexible system where the deferred SQL map generation option provides a more portable solution for object to application or object to data source (particularly O/R) mapping as opposed to the static option which allows for a more specific/optimized/tuned solution that may also require more sophisticated maintenance to stay specific/optimized/tuned when changes are made to the system, system environment, or system logic.

A yet further embodiment of the present invention provides integration of the above objects (mapping workspace, magic mapper, open repository architecture and static or deferred mapping option) with one or more third party IDEs, case tools, or development platforms as an extension or replacement component for such IDEs, case tools, or development platforms by integration of some or all of the above functionality into the third party platform or development environment so that the developer can have it as an add on to their development environment and into their development process.

A still further embodiment of the invention provide integration of the above systems and computer implemented logic with automatic, tunable, extensible, or managed code generation facilities to provide better code generation and manageability between the O/R, object to object application, or other object to data source mapping and subsequent code generation output in an automatic or semi-automatic manner as a consequence of using the systems and computer implemented embodiments of the invention as described above.

Another embodiment of the present invention provides such a system and computer implemented methods comprising a computer software component similar to a complex object that operates in an EJB environment, dot net, or the like, wherein the component has the capacity to access an object model repository or an instance thereof in a computer memory or in another temporary computer storage store device and persist multiple actions selected from the group consisting of creating, maintaining, accessing, navigating, updating or deleting complex data objects as a CDOG model as a true batch persistence process that is compatible with both the EJB environment and the structure of one or more underlying data source(s). In a preferred embodiment, the computer software component comprises an Enterprise Bean or dot net component selected from the group consisting of Stateless, Stateful and Entity Beans or consisting of one of a their dot net analog complex objects that coordinates with logic for ordering and parsing persistence of data in such a way that true batch persistence of both data objects and their relationships are persisted as a CDOG or dot net equivalent. In a further preferred embodiment the computer software component is an EJB Session Bean or dot net equivalent that is built on top of CocoBase runtime libraries or runtime dot net components having the ability to persist all or a portion of a CDOG model or instance thereof as a true batch process. An even more preferred embodiment of the invention provides such a computer software component capable of transparently persisting all or a portion of a CDOG model or instance thereof for a local or distributed computer system and automatically reconciling and persisting any changes to an instance of the CDOG model or any changes to the repository definition for the CDOG model as a batch process that takes into consideration relationships between data objects, such as parent/child, 1 to 1, 1 to many, and many to many such that dependent operations are executed after a necessary first operation. For example, parent persistence occurs before child persistence or parent objects and relationships are created, inserted, deleted or updated, before child objects and relationships are created, deleted inserted or updated.

A preferred embodiment of the present invention provides a software tool comprising the a navigation API and software component (as described above), adapted for a local network or a distributed network environment, wherein said software tool provides persistence transparently in an object oriented language environment (such as Java, C sharp, or dot net) by implementing a configurable network component capable of acquiring and persisting CDOGs or analogous dot net components through network APIs. A further object is a software tool associated with such an API, wherein the software analyzes persistence needs of a system to determine schema relationships in the application and cross-reference such relationships and data with the schema relationships and data in the underlying data source to permit parsing of persistence such that a true batch CDOG or equivalent dot net component persistence process can be executed, and executing such a process.

A further embodiment of the present invention provides a software tool capable of reading a source programming object logic model or a database file in a format selected from the group consisting of a UML data file, an XMI data file, and an XML file and converting the information into a target member selected from the group consisting of a database definition XML file, a database mapping definition file, and a CDOG definition file. In a preferred embodiment, the software can automatically generate a transparent persistence layer that corresponds to the object model information of the source file.

A further embodiment of the present invention is to provide a software module and source code known as a an Java entity bean (such as a generic session bean) or an equivalent dot net component that is capable of providing persistence of either or both of a data objects and a data model, in total or in part as determined through setting established by a user of the computer system, wherein the Java entity bean or dot net component is associated with one or more additional software module(s) and logic for ordering of the CDOG or equivalent dot net component to provide a true CDOG or equivalent dot net batch persistence capability of the software system.

Below are not limiting more specific descriptions of features and implementations of the invention as described above. Other implementations and applications of the concepts of the present invention will be apparent and they are also included as part of this invention. One example for implementing many of the above concepts is CocoBase version 5, scheduled to be published after this application is filed, and a number of its features are set forth below.

### CocoBase 5.00, Enterprise for O/R Implementation Overview Examples

### 1. Introduction

The text sections and examples below describe how to develop applications using CocoBase Enterprise O/R v.5.0 XML Repository Edition. The topics discussed below pertain mainly to examples for configuring and using CocoBase 5 XML Repositories and runtime APIS to systematically retrieve and persist object data. The XML Repository is like any other available CocoBase 5 repository implementation, but is conceptually a new repository design. But because mapping elements are specified by “human-readable” XML documents that can be created and edited as regular text documents, it requires no special tools in order to provide developers with access to O/R mapping features available in the CocoBase system. Therefore, it is a good starting point for developers to acquire a thorough understanding of system architecture and its capabilities.

### 2. Repositor Architecture

The CocoBase 5 repository architecture is an independent and unified set of mapping elements that are essentially devoted to describe how the system should provide persistence for one or more set of Java classes, or dot net components, available in applications. The CocoBase 5 repository has been specified as set of Java interfaces available in the com.thoughtinc.repository package (see Java documentation for more details), but a dot net version is readily implemented based upon this illustration. These interfaces establish a common protocol used by Java applications and tools to access repository contents at runtime. There are two types of elements in a CocoBase 5 repository: projects and maps, which are presented in more detail below.

### 2.1. Projects

A CocoBase 5 project can be defined as a set of higher level maps referred here as class mappings, where each class mapping refers to a ‘possibly’ existing Java class. Roughly speaking, there should be only one class mapping defined for each Java class within the context of a project, even though in more advanced scenarios a Java object instance can be mapped by different class mappings of a project at runtime. For most applications, one project with one class mapping per Java class would suffice. Some applications may require more than one (possibly shared) project, where each project provides different mappings for the each of the Java classes available in the application. For example, application A loads instances of classes C1 and C2 from data source DS1 and needs to store such instances into data source DS2. DS1 and DS2 are structured by different schema and tables (i.e. relational models differ between DS1 and DS2). For such scenario, that application could define two different projects P1 and P2 where P1 (used to load instances) contains the mappings from C1 and C2 to data source DS1 and P2 (used to store instances) has the mappings from C1 and C2 to data source DS2.

More precisely, a CocoBase 5 project can be seen as a name space where class mappings are defined so that each class mapping has a unique class name (which may or may not refer to an actual Java class available at runtime) within that project.

A project is identified by its name and each CocoBase 5 project is specified in its own XML file such as project_file_name.cbproject.xml. For example, a new CocoBase 5 project could be specified as follows:

```
<!-- CocoBase 5 project file default.cbproject.xml -->
<?xml version=‘1.0’ encoding=‘utf-8’?>
<!DOCTYPE project SYSTEM ‘cbproject-1.0.dtd’>
<project name=“default”>
                        . . .
                        <!-- class entries go here -->
                        . . .
</project>
```

Note that this XML repository implementation assumes that all project files (i.e., files terminated by .cbproject.xml) located under the same directory are part of the same repository. Once the XML respository is open in a specified directory location, its project contents can be accessed using available repository services.

An example of an XML definition of a CocoBase 5 project is shown below:

<!ELEMENT project (property-entry*, jdbc-connection?, runtime-settings?, class*)>
(1) <!ATTLIST project name CDATA #IMPLIED>
(2) <!ATTLIST project default-sql-prepend-schema (true | false) “true”>
(3) <!ATTLIST project default-sql-syntax (oracle | db2 | sybase | sql92 | auto) “auto”>
(4) <!ATTLIST project default-locking-strategy (optimistic | pessimistic) “optimistic”>
(5) <!ATTLIST project default-optimistic-lock (all | dirty) “all”>
(6) <!ATTLIST project default-member-accessor CDATA #IMPLIED>
(7) <!ATTLIST project default-instance-factory CDATA #IMPLIED>
(8) <!ATTLIST project default-batch-insert (true | false) “false”>
(9) <!ATTLIST project default-batch-update (true | false) “false”>
(10) <!ATTLIST project default-batch-delete (true | false) “false”>
(11) <!ATTLIST project default-cache-type (none | read-write) “none”>
(12) <!ATTLIST project default-cache-class CDATA #IMPLIED>

| | |
|---|---|
| (1) | name: specifies the project name. |
| (2) | default-sql-prepend-schema: specifies whether class mappings should by default |
| | include the schema name in table expressions of its generated sql. |
| (3) | default-sql-syntax: specifies the default sql syntax used by class mappings in their |
| | generated sql. |
| (4) | default-locking-strategy: specifies the default locking strategy used by class |
| | mappings in their generated sql. For optimistic (default) option, update and delete |
| | where clauses are generated for each attribute member defined in the class. For |
| | pessimistic option, update and delete where clauses are generated for each key |
| | attribute member defined in the class and a “for update” lock is appended to the |
| | select operation. |
| (5) | default-optimistic-lock: valid only for optimistic locking strategy, this specifies |
| | whether only dirty attribute member values should be included in update where |
| | clauses as opposed to all attribute values. |
| (6) | default-member-accessor: the default member accessor implementation to be used |
| | for all classes (see com.thoughtinc.runtime.MemberAccessor). If not specified, it |
| | refers to the default implementation which uses reflection for runtime access to |
| | class members. |
| (7) | default-instance-factory: the default instance factory implementation to be used for |
| | all classes (see com.thoughtinc.runtime.InstanceFactory). If not specified, it refers |
| | to the default implementation which uses the context class loader to load classes |
| | based on inheritance mapping information and creates instances through reflection |
| | (i.e. uses Class.newInstance( ) to instantiate objects, thus assuming an accessible |
| | empty constructor is defined for that class). |
| (8) | default-batch-insert: specifies whether sql insert statements should by default be |
| | organized and issued in batches whenever possible. This assumes the jdbc driver |
| | implementation in question supports batch updates. |
| (9) | default-batch-update: specifies whether sql update statements should by default be |
| | organized and issued in batches whenever possible. This assumes the jdbc driver |
| | implementation in question supports batch updates. |
| (10) | default-batch-delete: specifies whether sql delete statements should by default be |
| | organized and issued in batches whenever possible. This assumes the jdbc driver |
| | implementation in question supports batch updates. |
| (11) | default-cache-type: reserved for future use . . . |
| (12) | default-cache-class: reserved for future use . . . |

Most project attributes are used to specify defaults for class mappings. For instance, this is how one would specify that class mappings should by default use a pessimistic locking strategy:

```
<?xml version=‘1.0’ encoding=‘utf-8’?>
<!DOCTYPE project SYSTEM ‘cbproject-1.0.dtd’>
<project name=“default.xml” default-locking-strategy=“pessimistic”>
                        . . .
                        <!-- class entries go here -->
                        . . .
</project>
```

### 2.2. Maps

A typical CocoBase 5 repository can contain one of at least two types of maps: SQL maps and Procedure maps, and usually contains both along with other system logic and components.

### 2.2.1. SQL Maps

A sql map is a map that generically specifies how data fields map to database tables and columns is each sql operation (i.e., select, insert, update, delete). A sql map is an ‘abstract’ definition of the sql produced by the system when loading or persisting objects. It doesn't have to be attached to a particular Java object class or instance. In other words, a sql map is a separate programmatic entity that defines a ‘shape’ for persistence. It is neither integral to the objects that references it nor to the database tables that are referenced by it.

A sql map can be shared by several class maps in either the same or different projects and constitutes the very basic mapping element of the system. Most applications would not require to create or modify a sql map directly, although in some enterprise environments, specially when dealing with legacy databases, the ability to intercept and modify the sql that is generated by the mapping layer is a fundamental requirement. There are several scenarios where using sql maps directly can be interesting such as when there's need to tune and optimize the generated sql with the introduction of proprietary clauses or when sql function calls need to be ‘inlined’ within sql statements. When compared to relational database modeling features, a sql map can be defined as a shared updatable view that is defined on the client application side (rather than on the database server side), thus being ‘reusable’ across databases.

Another important feature of sql maps is that they can be used to route operations to procedure or function calls defined by procedure maps (discussed below). A more detailed explanation of sql maps is out of the scope of this document. The concept of sql map is based on patented technology of Thought Inc. (U.S. Pat. No. 5,857,197) and it is a unique feature when compared to other OR solutions.

### 2.2.2. Procedure Maps

Similarly to sql maps, a procedure map generically specifies how data fields map to database procedure or function calls. A procedure map is an ‘abstract’ definition of the jdbc call produced by the system when invoking procedures. Most applications would not require to create or modify a procedure maps directly, although in some enterprise environments, especially when dealing with legacy databases, the ability to issue procedure calls from within the application is an important requirement.

Procedure maps can also be used as a target for operations defined in a sql map so that whenever a sql operation is invoked for an object, a procedure map can be called as a replacement for the sql that would correspond to that operation. This is referred here as procedure routing. A more detailed explanation of procedure maps is out of the scope of this document.

### 3. Basic Mappings

Basic CocoBase 5 mapping illustrations are provided below.

### 3.1. Class Mapping

Classes are mapped by the class element. A class mapping is the most important mapping element within a project and it comprises a set of mappings that define how its members should be persisted in a set of database tables or how such members relate to each other or to other Java classes.

The XML definition of the class element is the following:

<!ELEMENT class (property-entry*,qualifier?,join*,default-inheritance?,subclass-
inheritance*,member*)>
(1) <!ATTLIST class name CDATA #REQUIRED>
(2) <!ATTLIST class abstract (true | false) “false”>
(3) <!ATTLIST class superclass-list CDATA #IMPLIED>
(4) <!ATTLIST class primary-table CDATA #IMPLIED>
(5) <!ATTLIST class proxy-class CDATA #IMPLIED>
(6) <!ATTLIST class sql-map CDATA #IMPLIED>
(7) <!ATTLIST class sql-prepend-schema (true | false) #IMPLIED>
(8) <!ATTLIST class sql-syntax (oracle | db2 | sybase | sql92 | auto) #IMPLIED>
(9) <!ATTLIST class locking-strategy (optimistic | pessimistic) #IMPLIED>
(10) <!ATTLIST class optimistic-lock (all | dirty) #IMPLIED>
(11) <!ATTLIST class member-accessor CDATA #IMPLIED>
(12) <!ATTLIST class instance-factory CDATA #IMPLIED>
(13) <!ATTLIST class cache-type (none | read-write) #IMPLIED>
(14) <!ATTLIST class cache-class CDATA #IMPLIED>

| | |
|---|---|
| (1) | name: specifies the class name. This usually refers to the name of a Java class that |
| | is available at runtime. |
| (2) | abstract: when set to true indicates the generated sql should not include update, |
| | delete or insert statements for this class. |
| (3) | superclass-list: a comma-separated list with the superclasses of this class. Projects |
| | do not distinguish between Java classes and interfaces and multiple inheritance |
| | scenarios are mapped with more than one class in the superclass list. Usually the |
| | first class name in the superclass list corresponds to the Java class being extended |
| | by the mapped class (i.e. the actual Java superclass) whereas the remaining class |
| | names in the list refer to interfaces implemented by the mapped class (i.e. Java |
| | interfaces). |
| (4) | primary-table: the table with the columns that identify instances of this class (i.e. |
| | primary keys). Key attribute members must map to columns defined in the primary |
| | table. When not specified, it is assumed no table exists for this class and column |
| | mappings should be properly specified in subclass mappings. |
| (5) | proxy-class: reserved for future use . . . |
| (6) | sql-map: the name of the sql map containing the sql to be used for this class |
| | mapping. When not specified, it is assumed that sql should be dynamically |
| | generated at runtime. |
| (7) | sql-prepend-schema: specifies whether this class mapping should include the |
| | schema name in table expressions of its generated sql. Overrides project settings for |
| | default-sql-prepend-schema (see above). |
| (8) | sql-syntax: specifies the default sql syntax used by this class mapping in its |
| | generated sql. Overrides project settings for default-sql-syntax (see above). |
| (9) | locking-strategy: specifies the default locking strategy used by this class mapping in |
| | its generated sql. Overrides project settings for default-locking-strategy (see above). |
| (10) | optimistic-lock: specifies whether the runtime should include only dirty attribute |
| | member values in where clauses as opposed to all of the attribute values. Overrides |
| | project settings for default-optimistic-lock (see above). |
| (11) | member-accessor: the member accessor implementation to be used for this class. |
| | Overrides project settings for default-member-accessor (see above). |
| (12) | default-instance-factory: the instance factory implementation to be used for this |
| | classes. Overrides project settings for default-instance-factory (see above). |
| (13) | default-cache-type: reserved for future use . . . |
| (14) | default-cache-class: reserved for future use . . . |

### 3.2. Member Mapping

Class mappings comprise a set of member mappings, which describe how a given class property (i.e. usually represented in Java by a get/set pair of methods) or a field is mapped. Generally speaking, a member can be mapped as a regular data attribute, a relationship ‘link’ (i.e. one-to-one, one-to-many, many-to-one, many-to-many) to related instances of other classes mapped within the same project, or it can be even defined as a composite of other members (which in turn can also be composite, thus allowing nesting of members to any level).

Member mappings are specified by the member element and its XML definition is the following:

<!ELEMENT member (property-entry*,(attribute | one-to-one | one-to-many | many-to-one |
many-to-many | composite))>
(1) <!ATTLIST member name CDATA #REQUIRED>
(2) <!ATTLIST member access-mode (none | field | property | auto) #IMPLIED>
(3) <!ATTLIST member accessor CDATA #IMPLIED>
(4) <!ATTLIST member mutator CDATA #IMPLIED>

| | |
|---|---|
| (1) | name: specifies the member name. |
| (2) | access-mode: used to indicate how the runtime should access this member. This can |
| | be set to none to indicate that this member does not actually exist in the Java class, |
| | that is, such member is not accessible. However, its mappings are required by other |
| | member references and it holds data that is internally recognized by the system at |
| | runtime. |
| (3) | accessor: valid only when access-mode is property, in which case it indicates the |
| | method used to obtain the value for that property. When not specified, it defaults to |
| | get{Member-name}. For instance, for a member called “price”, the default accessor |
| | is assumed to be getPrice( ). |
| (4) | mutator: valid only when access-mode is property, in which case it indicates the |
| | method used to modify the value for that property. When not specified, it defaults to |
| | set{Member-name}. For instance, for a member called “price”, the default mutator |
| | is assumed to be setPrice( ). |

Note that (2), (3) and (4) are relevant only for the default accessor implementation provided by the system (see com.thoughtinc.runtime.MemberAccessor javadocs for details). When a ‘custom’ member accessor implementation is specified for the class, it is up to that implementation to decide when and how the given class members can be accessed.

### 3.2.1. Attribute Mapping

The attribute element is used to map a member that holds a single and indivisible (i.e. atomic) data value, such as a String or int. It normally maps to a specific column of a table. The XML definition of an attribute mapping is:

<!ELEMENT attribute (generator?)>
(1) <!ATTLIST attribute key (true | false) #IMPLIED>
(2) <!ATTLIST attribute mode CDATA #IMPLIED>
(3) <!ATTLIST attribute column CDATA #IMPLIED>
(4) <!ATTLIST attribute data-type CDATA #IMPLIED>
(5) <!ATTLIST attribute db-type CDATA #IMPLIED>
(6) <!ATTLIST attribute size CDATA #IMPLIED>
(7) <!ATTLIST attribute searchable (true | false) #IMPLIED>
(8) <!ATTLIST attribute signed (true | false) #IMPLIED>
(9) <!ATTLIST attribute null-value CDATA #IMPLIED>

| | |
|---|---|
| (1) | key: whether this member is a key attribute (used to uniquely identify the object) or |
| | not (default). |
| (2) | mode-list: a comma-separated list of access modes for this attribute. Accepted values |
| | are read, write, modify, qbe, update-lock, delete-lock and all where: |
| | read indicates the attribute value should be included as part of sql that selects |
| | objects from the database |
| | write indicates the attribute value should be included as part of sql that inserts |
| | objects into the database |
| | modify indicates the attribute value should be included as part of sql that updates |
| | objects into the database |
| | qbe indicates the attribute value should be included as part of sql where |
| | conditions to select objects from the database using query-by-example |
| | delete-lock indicates the attribute value should be included as part of sql where |
| | conditions for optimistic locking when deleting objects from the database (this |
| | only holds when the class locking strategy is specified as optimistic - see |
| | above). |
| | update-lock indicates the attribute value should be included as part of sql where |
| | conditions for optimistic locking when updating objects in the database (this |
| | only holds when the class locking strategy is specified as optimistic - see |
| | above). |
| | all combines all of the above (default) |
| (3) | column: the name of the database column where the attribute value is stored. The |
| | column name must be qualified by the table name where the column is defined. For |
| | example, sales.product.retail_price indicates this column is defined in table product |
| | available in the database schema sales. The schema name is optional. In case the |
| | attribute column is not specified, the attribute remains unmapped for this particular |
| | class. For the case where there's no primary table defined for the class, that is, the |
| | class is unmapped, all of its attributes must also be left unmapped. |
| (4) | data-type: the data type used to load or store the value for this attribute. Internally, |
| | this determines the jdbc type the system will use obtain or modify the data. Available |
| | data-types are: bit, tinyint, smallint, integer, bigint, real, float, double, numeric, |
| | decimal, char, varchar, longvarchar, date, time, timestamp, binary, varbinary, |
| | longvarbinary, java-object, distinct, struct, array, blob, clob, ref, null, other, calendar |
| | and its correspondence to Java types is the same as that given by the jdbc |
| | specification. |
| (5) | db-type: a string that describes how the given data type is represented in the target |
| | database. This is an optional attribute and its value can be obtained automatically by |
| | the system. |
| (6) | size: a string indicating the size (in length) used in the target database to store the |
| | data. This is an optional attribute and its value can be automatically inferred by the |
| | system. |
| (7) | searchable: indicates whether the target database supports search expressions on the |
| | data mapped by this attribute or not. This is an optional attribute and its value can be |
| | automatically inferred by the system. |
| (8) | signed: indicates whether this attribute maps to signed values or not. This is an |
| | optional attribute and its value can be automatically inferred by the system. |
| (9) | null-value: valid only when the corresponding Java member is of a primitive type and |
| | specifies the value that should be used to indicate a database null or non-initialized |
| | value. When not specified, it is assumed to be the MIN_VALUE constant defined for |
| | that type. |

The example below illustrates the mapping of a class called com.foo.Product and its respective attribute members to a table called t_product and respective columns:

```
<class name=“com.foo.Product” primary-table=“t_product”>
    <member name=“id”>
        <attribute data-type=“bigint” column=“t_product.id”
        key=“true”/>
    </member>
    <member name=“name” access=“property”>
        <attribute data-type=“varchar” column=“t_product.name”/>
    </member>
    <member name=“price” access=“field”>
        <attribute data-type=“real” column=“t_product.price”/>
    </member>
</class>
```

Note that the member id is set as the key attribute for com.foo.Product. That means its values can uniquely identify instances within that class, thus providing object identity to such objects instances. As mentioned previously, key attribute members must always map to columns belonging to the primary table of the class in question.

### 3.2.2. One-to-One Relationship Mapping

The one-to-one element is used to map a member that represents a one-to-one relationship to another object. The XML definition of a one-to-one mapping is:

<!ELEMENT one-to-one (qualifier?)>
(1) <!ATTLIST one-to-one target-class CDATA #IMPLIED>
(2) <!ATTLIST one-to-one inverse-of CDATA #IMPLIED>
(3) <!ATTLIST one-to-one load-mode (lazy | all | none) “all”>
(4) <!ATTLIST one-to-one cascade-insert (all | thru | none ) “all”>
(5) <!ATTLIST one-to-one cascade-delete (all | thru | none ) “thru”>
(6) <!ATTLIST one-to-one cascade-update (all | thru | none ) “all”>
(7) <!ATTLIST one-to-one local-key-list CDATA #IMPLIED>
(8) <!ATTLIST one-to-one target-key-list CDATA #IMPLIED>
(9) <!ATTLIST one-to-one foreign-key (local | target) #IMPLIED>

| | |
|---|---|
| (1) | target-class: specifies the class name of the related object. The target class name |
| | must refer to a class defined within the same project. |
| (2) | inverse-of: used to indicate the inverse of this one-to-one member. Specifying a |
| | relationship member as the inverse of another indicates that the system should try to |
| | maintain an integrity constraint so that both members refer to each other while such |
| | relationship is established (this will be explained in more detail later). The inverse |
| | setting is particularly useful when the target Java class holds a ‘back-reference’ to |
| | the class being mapped. |
| (3) | load-mode: specifies the mode used for loading the related objects. all indicates the |
| | related object should be loaded along with the object in question. lazy indicates that |
| | the related object should be loaded only when there's a request to access such |
| | object. |
| (4) | cascade-insert: indicates how insertion should be cascaded to a related object. It |
| | only applies when the related object is detected by the system as ‘transient’ (i.e. it |
| | does not exist in the database) and there's a request to update or insert the object in |
| | question. all indicates the system should also insert the related object. thru indicates |
| | the system should not insert the related object but it should proceed to processing |
| | objects that have relationships with the related object. none indicates the system |
| | should neither insert the related object nor proceed to processing objects that have |
| | relationships with the related object (i.e. it should stop traversing any relationships |
| | as it reaches the related object). |
| (5) | cascade-delete: indicates how deletion should be cascaded to a related object. It |
| | only applies when the related object is ‘persistent’ (i.e. it exists in the database) and |
| | there's a request to delete the relationship with the object in question (or the object |
| | itself is being deleted along with its relationships). all indicates the system should |
| | also delete the related object. thru indicates the system should not delete the related |
| | object but it should proceed to processing objects that have relationships with the |
| | related object. none indicates the system should neither delete the related object nor |
| | proceed to processing objects that have relationships with the related object (i.e. it |
| | should stop traversing any relationships as it reaches the related object). |
| (6) | cascade-update: indicates how updates should be cascaded to a related object. It |
| | only applies when the related object is ‘persistent’ (i.e. it exists in the database) and |
| | there's a request to update or insert the object in question. all indicates the system |
| | should also update the related object. thru indicates the system should not update |
| | the related object but it should proceed to processing objects that have relationships |
| | with the related object. none indicates the system should neither update the related |
| | object nor proceed to processing objects that have relationships with the related |
| | object (i.e. it should stop traversing any relationships as it reaches the related |
| | object). |
| (7) | local-key-list: specifies a comma-separated list of attribute members in this class |
| | that map to the local database key columns. |
| (8) | target-key-list: specifies a comma-separated list of attribute members in the target |
| | class that map to the target database key columns. |
| (9) | foreign-key: indicates whether database foreign key columns that represent this |
| | relationship are mapped by the local keys or by the target keys. |

For example, assume the existence of two Java classes com.foo.Customer and com.foo.Address (implementation not included) as follows:

```
/**
* Class com.foo.Customer
*/
package com.foo;
public class Customer extends Object {
    public Long getId( ) { . . . }
    public void setId(Long id) { . . . }
    public String getName( ) { . . . }
    public void setName(String name) { . . . }
    public void setAddress(Address address) { . . . }
    public Address getAddress( ) { . . . }
}
```

```
/**
* Class com.foo.Address
*/
package com.foo;
public class Address extends Object {
    public Long getId( ) { . . . }
    public void setId(Long id) { . . . }
    public String getStreet( ) { . . . }
    public void setStreet(String street) { . . . }
    public Integer getNum( ) { . . . }
    public void setNum(Integer num) { . . . }
    public String getZip( ) { . . . }
    public void setZip(String street) { . . . }
}
```

According to the classes above, the one-to-one relationship from com.foo.Customer to com.foo.Address is represented by the property address defined in com.foo.Customer as a pair of public accessor methods, namely getAddress( ) and setAddress(com.foo.Address). Now assume that for each of these classes, two database tables have been created like below:

```
CREATE TABLE t_customer (
    id BIGINT,
    name VARCHAR(50),
    address_id BIGINT,
PRIMARY KEY (id),
FOREIGN KEY (address_id) REFERENCES t_address (id));
```

```
CREATE TABLE t_address (
    id BIGINT,
    street VARCHAR(50),
    num INTEGER,
    zip VARCHAR(10),
PRIMARY KEY (id));
```

In the tables above, the one-to-one relationship between t_customer and t_address is represented by the foreign key address_id defined in t_customer.

This is how one could define mappings between the above classes and tables:

```
<?xml version=‘1.0’ encoding=‘utf-8’?>
<!DOCTYPE project SYSTEM ‘cbproject-1.0.dtd’>
<project name=“default”>
    <class name=“com.foo.Address” primary-table=“t_address”>
        <member name=“id”>
            <attribute column=“t_address.id” data-type=“bigint”
            key=“true”/>
        </member>
        <member name=“street”>
            <attribute column=“t_address.street”
            data-type=“varchar”/>
        </member>
        <member name=“num”>
            <attribute column=“t_address.num”
            data-type=“integer”/>
        </member>
        <member name=“zip”>
            <attribute column=“t_address.zip”
            data-type=“varchar”/>
        </member>
    </class>
    <class name=“com.foo.Customer” primary-table=“t_customer”>
        <member name=“id”>
            <attribute column=“t_customer.id” data-type=“bigint”
            key=“true”/>
        </member>
        <member name=“name”>
            <attribute column=“t_customer.name”
            data-type=“varchar”/>
        </member>
        <member name=“@addressId” access-mode=“none”>
            <attribute column=“t_customer.address_id”
            data-type=“bigint”/>
        </member>
        <member name=“address”>
            <one-to-one
                target-class=“com.foo.Address”
                local-key-list=“@addressId”
                target-key-list=“id”
                foreign-key=“local”
                cascade-delete=“all”
            />
        </member>
    </class>
</project>
```

A few important things can be observed in this simple example. The name of the related class com.foo.Address is specified by target-class. Note cascade-delete is set to all to indicate that the related address should be deleted along with the customer being deleted. Also note that local-key-list and target-key-list to refer to a list of other local and target (i.e. defined in the target class) attribute members rather than referring directly to the database key columns the represent the relationship between the tables. So, in order for this one-to-one mapping entry to be valid, such members must be defined within the respective class mappings prior to being referred from within a one-to-one mapping. That explains why the key @addressId is defined as a local attribute member that maps the foreign key column address_id defined in t_customer. The member @addressId does not actually exist in the Java class and its access-mode is set to none (the preceding ‘@’ character is not a requirement but just a name convention to indicate that is a virtual member mapping that does not refer to an actual Java member).

The reason such indirect mapping approach is used for mapping relationship keys is that it allows subclasses to easily override relationship mappings by simply specifying a different table or column for the @addressId attribute mapping. Further, for the case where there is no table defined for com.foo.Customer (i.e. the superclass is abstract and only its subclasses map to actual tables), it is still possible to specify the one-to-one relationship to com.foo.Address by simply leaving the @addressId column unspecified. The system will then assume subclasses will provide concrete column mappings for it. Other scenarios where the use of virtual members becomes necessary are presented later.

### 3.2.3 One-to-Many Relationship Mapping

One-to-many relationships between objects are mapped using the one-to-many element. Below is the XML definition of a one-to-many mapping:

<!ELEMENT one-to-many (qualifier?)>
(1) <!ATTLIST one-to-many target-class CDATA #IMPLIED>
(2) <!ATTLIST one-to-many inverse-of CDATA #IMPLIED>
(3) <!ATTLIST one-to-many load-mode (lazy | all | none) “all”>
(4) <!ATTLIST one-to-many cascade-insert (all | thru | none ) “all”>
(5) <!ATTLIST one-to-many cascade-delete (all | thru | none ) “thru”>
(6) <!ATTLIST one-to-many cascade-update (all | thru | none ) “all”>
(7) <!ATTLIST one-to-many local-key-list CDATA #IMPLIED>
(8) <!ATTLIST one-to-many target-key-list CDATA #IMPLIED>
(9) <!ATTLIST one-to-many order-key CDATA #IMPLIED>

| | |
|---|---|
| (1) | target-class: specifies the class name of the related object. The target class name |
| | must refer to a class defined within the same project. |
| (2) | inverse-of: used to indicate the inverse of this one-to-one member. Specifying a |
| | relationship member as the inverse of another indicates that the system should try to |
| | maintain an integrity constraint so that both members refer to each other while such |
| | relationship is established (this will be explained in more detail later). The inverse |
| | setting is particularly useful when the target Java class holds a ‘back-reference’ to |
| | the class being mapped. |
| (3) | load-mode: specifies the mode used for loading the related objects. all indicates the |
| | related object should be loaded along with the object in question. lazy indicates that |
| | the related object should be loaded only when there's a request to access such |
| | object. |
| (4) | cascade-insert: indicates how insertion should be cascaded to a related object. It |
| | only applies when the related object is detected by the system as ‘transient’ (i.e. it |
| | does not exist in the database) and there's a request to update or insert the object in |
| | question. all indicates the system should also insert the related object. thru indicates |
| | the system should not insert the related object but it should proceed to processing |
| | objects that have relationships with the related object. none indicates the system |
| | should neither insert the related object nor proceed to processing objects that have |
| | relationships with the related object (i.e. it should stop traversing any relationships |
| | as it reaches the related object). |
| (5) | cascade-delete: indicates how deletion should be cascaded to a related object. It |
| | only applies when the related object is ‘persistent’ (i.e. it exists in the database) and |
| | there's a request to delete the relationship with the object in question (or the object |
| | itself is being deleted along with its relationships). all indicates the system should |
| | also delete the related object. thru indicates the system should not delete the related |
| | object but it should proceed to processing objects that have relationships with the |
| | related object. none indicates the system should neither delete the related object nor |
| | proceed to processing objects that have relationships with the related object (i.e. it |
| | should stop traversing any relationships as it reaches the related object). |
| (6) | cascade-update: indicates how updates should be cascaded to a related object. It |
| | only applies when the related object is ‘persistent’ (i.e. it exists in the database) and |
| | there's a request to update or insert the object in question. all indicates the system |
| | should also update the related object. thru indicates the system should not update |
| | the related object but it should proceed to processing objects that have relationships |
| | with the related object. none indicates the system should neither update the related |
| | object nor proceed to processing objects that have relationships with the related |
| | object (i.e. it should stop traversing any relationships as it reaches the related |
| | object). |
| (7) | local-key-list: specifies a comma-separated list of attribute members in this class |
| | that map to the local database key columns. |
| (8) | target-key-list: specifies a comma-separated list of attribute members in the target |
| | class that map to the target database key columns. |
| (9) | order-key: specifies the name of the attribute member in this class that map to the |
| | database ordering column. When not specified, the collection of related objects is |
| | assumed to be unordered, and the order related objects are retrieved from or stored |
| | in the database is system specific. |

In a Java class, a one-to-many relationship between objects is normally represented by the use of a java.util.Collection subtype such as Set or List. Object arrays and Map subtypes are also allowed. The system makes no distinction regarding the semantics of the type used to represent the relationship, which means that it is up to the developer to choose the best fit for holding the collection of related objects. Legacy classes where java.util. Vector and java.util. Hashtable are used to represent such relationships can also be mapped without the need to be changes or recompiled. Customjava util Collection or java.util. Map subclasses can also be used for that purpose. Note however that differently from Java collections, relationship mappings are typed according to the value of target-class. That means the elements that appear in the Java collection must be objects compatible with the class referred by target-class.

For example, let's say we have the following methods defined in class com.foo.Customer:

```
/**
* Class com.foo.Customer
*/
package com.foo;
public class Customer extends Object {
    . . .
    public void setOrders(Set orders) { . . . }
    public Set getOrders( ) { . . . }
}
```

The order Set is assumed to contain instances of the class com.foo.Order defined as follows:

```
/**
* Class com.foo.Order
*/
package com.foo;
public class Order extends Object {
    public Long getId( ) { . . . }
    public void setId(Long id) { . . . }
    public Float getTotal( ) { . . . }
    public void setTotal(Float total) { . . . }
    public java.sql.Date getDate( ) { . . . }
    public void setDate(java.sql.Date date) { . . . }
}
```

Also assume the database table where customer order information is stored has been created as below:

```
CREATE TABLE t_order (
    id BIGINT,
    total REAL,
    order_date DATE,
    customer_id BIGINT,
PRIMARY KEY (id),
FOREIGN KEY (customer_id) REFERENCES t_customer(id));
```

According to the above, this is how mappings could be specified:

```
<?xml version=‘1.0’ encoding=‘utf-8’?>
<!DOCTYPE project SYSTEM ‘cbproject-1.0.dtd’>
<project name=“default”>
  <class name=“com.foo.Order” primary-table=“t_order”>
    <member name=“id”>
      <attribute column=“t_order.id” data-type=“bigint” key=“true”/>
    </member>
    <member name=“total”>
      <attribute column=“t_order.total” data-type=“real”/>
    </member>
    <member name=“date”>
      <attribute column=“t_order.order_date” data-type=“date”/>
    </member>
    <member name=“@customerId” access-mode=“none”>
      <attribute column=“t_order.customer_id” data-type=“bigint”/>
    </member>
  </class>
  <class name=“com.foo.Customer” primary-table=“t_customer”>
    <member name=“id”>
      <attribute column=“t_customer.id” data-type=“bigint”
      key=“true”/>
    </member>
    <member name=“name”>
      <attribute column=“t_customer.name” data-type=“varchar”/>
    </member>
    ...
    <member name=“orders”>
      <one-to-many
        target-class=“com.foo.Order”
        local-key-list=“id”
        target-key-list=“@customerId”
        cascade-delete=“all”
      />
    </member>
  </class>
</project>
```

Now let us suppose that List is used to hold the related orders of a customer rather than Set:

```
public class Customer extends Object {
    . . .
    public void setOrders(List orders) {...}
    public List getorders() {...}
}
```

In the example above, the project mappings don't need to change and the List instance would be properly populated with the related orders. However, assume the reason List was chosen was because it is important to keep customer orders properly positioned in the list. Also, assume that a column order_idx is included in the t_order table with the purpose of storing that positioning information, such as below:

```
CREATE TABLE t_order {
    id BIGINT,
    total REAL,
    order_date DATE,
    order_idx INTEGER,
    customer_id BIGINT,
PRIMARY KEY (id),
FOREIGN KEY (customer_id) REFERENCES t_customer(id));
```

For scenarios like this, it is possible to specify how one-to-many mappings should persist ordering (i.e. positioning) data for the collection of related objects. That can be done by setting order-key to an (usually virtual) attribute member that maps to the ordering column:

```
<class name=“com.foo.Order” primary-table=“t_order”>
    . . .
    <member name=“@customerId” access-mode=“none”>
        <attribute column=“t_order.customer_id” data-type=“bigint”/>
    </member>
    <member name=“@orderIndex” access-mode=“none”>
        <attribute column=“t_order.order_idx” data-type=“integer”/>
    </member>
</class>
<class name=“com.foo.Customer” primary-table=“t_customer”>
    . . .
    <member name=“orders”>
        <one-to-many
            target-class=“com.foo.Order”
            local-key-list=“id”
            target-key-list=“@customerId”
            ordar-key=“@orderIndex”
            cascade-delete=“all”
        />
    </member>
</class>
```

While a one-to-many relationship that refers to an order-key attribute is being persisted, the corresponding ordering column will be populated with the position of the related object within the original collection that represents that relationship. Similarly, while loading that relationship, the collection of related objects will be ordered by the values stored in the ordering column. This mechanism assures that the order in which objects are loaded is the same as when objects were stored in the collection, thus better preserving the semantics of ordered collection types such as java.util.List.

### 3.2.4. Many-to-One Relationship Mapping

The many-to-one element is usually used to map the inverse end of one-to-many relationships, although it does not require that a one-to-many inverse relationship be specified. Its XML definition is reproduced below:

<!ELEMENT many-to-one (qualifier?)>
(1) <!ATTLIST many-to-one target-class CDATA #IMPLIED>
(2) <!ATTLIST many-to-one inverse-of CDATA #IMPLIED>
(3) <!ATTLIST many-to-one load-mode (lazy | all | none) “all”>
(4) <!ATTLIST many-to-one cascade-insert (all | thru | none ) “all”>
(5) <!ATTLIST many-to-one cascade-delete (all | thru | none ) “thru”>
(6) <!ATTLIST many-to-one cascade-update (all | thru | none ) “all”>
(7) <!ATTLIST many-to-one local-key-list CDATA #IMPLIED>
(8) <!ATTLIST many-to-one target-key-list CDATA #IMPLIED>

The above many-to-one settings from (1) to (8) should be specified exactly as described earlier for one-to-one and one-to-many relationship mapping elements (see above). As an example, suppose we add methods to set and modify the related customer to the com.foo.Order class:

```
/**
* Class com.foo.Order
*/
package com.foo;
public class Order extends Object {
    public Long getId( ) { . . . }
    public void setId(Long id) { . . . }
    public Float getTotal( ) { . . . }
    public void setTotal(Float total) { . . . }
    public java.sql.Date getDate( ) { . . . }
    public void setDate(java.sql.Date date) { . . . }
    public Customer getCustomer( ) { . . . }
    public void setCustomer(Customer customer) { . . . }
}
```

The many-to-one reference to customer would then be mapped as below:

```
<class name=“com.foo.Order” primary-table=“t_order”>
    . . .
    <member name=“@customerId” access-mode=“none”>
        <attribute column=“t_order.customer_id” data-type=“bigint”/>
    </member>
    . . .
    <member name=“customer”>
        <many-to-one
            taget-class=“com.foo.Customer”
            local-key-list=“@customerId”
            target-key-list=“id”
            cascade-delete=“none”
        />
    </member>
</class>
```

By looking only at the Java class, a many-to-one reference is just like a one-to-one reference, that is, it refers to one single object. However, the underlying mapping semantics is different. Should the customer member above be mapped as a one-to-one, it would not be possible to store an order that refers to a customer that is already related to other orders. So, not only the system is aware of which order is related to a given customer, but it also tries to maintain that relationship consistent according to respective mappings. Note also that cascade-delete is set to none to prevent one order from deleting other related orders “through” that same customer (which might happen in case it is left to the default setting “thru” and customer is cascading deletion to “all”).

When the same table relationship is also mapped as a one-to-many in the target class, then both relationship mappings must be declared as ‘inverse’ of each other. For instance, assume com.foo.Customer also keeps a Set called orders to refer to related orders. This is how the mappings would be specified:

```
<?xml version=‘1.0’ encoding=‘utf-8’?>
<!DOCTYPE project SYSTEM ‘cbproject-1.0.dtd’>
<project name=“default”>
    <class name=“com.foo.Order” primary-table=“t_order”>
        <member name=“id”>
            <attribute column=“t_order.id” data-type=“bigint” key=“true”/>
        </member>
        <member name=“total”>
            <attribute column=“t_order.total” data-type=“real”/>
        </member>
        <member name=“date”>
            <attribute column=“t_order.order_date” data-type=“date”/>
        </member>
        <member name=“@customerId” access-mode=“none”>
            <attribute column=“t_order.customer_id” data-type=“bigint”/>
        </member>
        <member name=“customer”>
            <many-to-one
                target-class=“com.foo.Customer”
                inverse-of=“orders”
                local-key-list=“@customerId”
                target-key-list=“id”
                cascade-delete=“none”
            />
        </member>
    </class>
    <class name=“com.foo.Customer” primary-table=“t_customer”>
        <member name=“id”>
            <attribute column=“t_customer.id” data-type=“bigint” key=“true”/>
        </member>
        <member name=“name”>
            <attribute column=“t_customer.name” data-type=“varchar”/>
        </member>
        . . .
        <member name=“orders”>
            <one-to-many
                target-class=“com.foo.Order”
                inverse-of=“customer”
                local-key-list=“id”
                target-key-list=“@customerId”
                cascade-delete=“all”
            />
        </member>
    </class>
</project>
```

When no value is specified for inverse-of the system will consider there are in fact two separate relationships between customers and orders, and it will end up trying to persist or load the related objects more than once, which can certainly lead to problems when inserting or updating related objects. Other implications regarding the use of inverse-of relationship mappings are explained later.

### 3.2.5. Many-to-Many Relationship Mapping

Many-to-many relationships are specified by the many-to-many XML element, as defined below:

<!ELEMENT many-to-many (qualifier?,many-to-many-keys?, many-to-many-key-mapping*)>

| | |
|---|---|
| (1) | <!ATTLIST many-to-many target-class CDATA #IMPLIED> |
| (2) | <!ATTLIST many-to-many inverse-of CDATA #IMPLIED> |
| (3) | <!ATTLIST many-to-many load-mode (lazy \| all \| none) “all”> |
| (4) | <!ATTLIST many-to-many insert-cascade (all \| thru \| none ) “all”> |
| (5) | <!ATTLIST many-to-many delete-cascade (all \| thru \| none ) “thru”> |
| (6) | <!ATTLIST many-to-many update-cascade (all \| thru \| none ) “all”> |
| (7) | <!ATTLIST many-to-many local-key-list CDATA #IMPLIED> |
| (8) | <!ATTLIST many-to-many target-key-list CDATA #IMPLIED> |
| (9) | <!ATTLIST many-to-many many-to-many-table CDATA #IMPLIED> |
| (10) | <!ATTLIST many-to-many many-to-many-sql-map CDATA #IMPLIED> |
| (11) | <!ATTLIST many-to-many many-to-many-local-key-list CDATA #IMPLIED> |
| (12) | <!ATTLIST many-to-many many-to-many-target-key-list CDATA #IMPLIED> |
| (13) | <!ATTLIST many-to-many many-to-many-order-key CDATA #IMPLIED> |

The above many-to-many settings from (1) to (8) should be specified exactly as described earlier for <one-to-one> and <one-to-many> relationship mapping elements (see above). There are some additional settings specific to many-to-many relationship mappings:
(1) many-to-many-table: many-to-many relationships cannot be represented directly in the database by foreign keys between the related tables. A third ‘associative’ table that refers to both related tables is required to store relationship instances. This specifies the name of associative database table that represents this many-to-many relationship in the database.
(2) many-to-many-sql-map: the name of the sql map containing the sql to be used for selecting, inserting, updating or deleting entries of the corresponding many-to-many table. When not specified, it is assumed that the sql should be generated at runtime.
(3) many-to-many-local-key-list: specifies the keys (many-to-many key mappings are explained below) that map to the foreign key columns (in the many-to-many table) referencing the columns mapped by local-key-list.
(4) many-to-many-target-key-list: specifies the keys (many-to-many key mappings are explained below) that map to the foreign key columns (in the many-to-many table) referencing the columns mapped by target-key-list.
(5) many-to-many-order-key: specifies the key (many-to-many key mappings are explained below) that map to the many-to-many database column used to keep ordering information of related objects (i.e. instances of the target class). When not specified, the collection of related objects is assumed to be unordered, and the order related objects are retrieved from or stored in the database is system specific.

Note that many-to-many-local-key-list, many-to-many-target-key-list and many-to-many-order-key refer not to actual columns of the many-to-many associative table, but to key mappings to those columns instead. Similarly to class local and target key mappings, this indirect mapping allows the relationship to be ‘abstractly’ mapped so concrete column mappings can be specified in subclasses. Many-to-many key mappings are specified by a list of <many-to-many-key-mapping> elements, defined as follows:

<!ELEMENT many-to-many-key-mapping EMPTY>
(1) <!ATTLIST many-to-many-key-mapping key CDATA #REQUIRED>
(2) <!ATTLIST many-to-many-key-mapping column CDATA #REQUIRED>
(3) <!ATTLIST many-to-many-key-mapping data-type CDATA #REQUIRED>
(4) <!ATTLIST many-to-many-key-mapping db-type CDATA #IMPLIED>
(5) <!ATTLIST many-to-many-key-mapping size CDATA #IMPLIED>
(6) <!ATTLIST many-to-many-key-mapping searchable (true | false) #IMPLIED>
(7) <!ATTLIST many-to-many-key-mapping signed (true | false) #IMPLIED>

| | |
|---|---|
| (1) | key: the name of the many-to-many key being mapped. |
| (2) | column: the name of the database column in the associative table where the key |
| | value is stored. The column name must be qualified by the many-to-many table |
| | name where the column is defined. For example, |
| | research.project_by_reseacher.project_name indicates this column is defined in the |
| | associative table project_by_reseacher available in the database schema research. |
| | The schema name is optional. |
| (3) | data-type: the data type used to load or store the value for this key. Internally, this |
| | determines the database type the system will use obtain or modify the data. |
| | Available data-types are: bit, tinyint, smallint, integer, bigint, real, float, double, |
| | numeric, decimal, char, varchar, longvarchar, date, time, timestamp, binary, |
| | varbinary, longvarbinary, java-object, distinct, struct, array, blob, clob, ref, null, |
| | other, calendar and its correspondence to Java types is the same as that given by the |
| | jdbc specification. |
| (4) | db-type: a string that describes how the given data type is represented in the target |
| | database. This is an optional attribute and its value can be inferred by the system. |
| (5) | size: a string indicating the size (in length) used in the target database to store the |
| | data. This is an optional attribute and its value can be automatically inferred by the |
| | system. |
| (6) | searchable: indicates whether the target database supports search expressions on the |
| | data mapped by this key or not. This is an optional attribute and its value can be |
| | automatically inferred by the system. |
| (7) | signed: indicates whether this key maps to signed values or not. This is an optional |
| | attribute and its value can be automatically inferred by the system. |

Many-to-many relationships are represented in Java usually by declaring fields of Collection or Map subtypes in both classes. These fields hold collection of objects that refer to each other. For example, let us assume there is a many-to-many relationship between classes com.foo.Product and com.foo.Supplier. These are defined as in the code below:

```
/**
* Class com.foo.Product
*/
package com.foo;
public class Product extends Object {
    public Long getId( ) { . . . }
    public void setId(Long id) { . . . }
    public String getName( ) { . . . }
    public void setName(String name) { . . . }
    public Float getPrice( ) { . . . }
    public void setPrice(Float price) { . . . }
    public void setSuppliers(Collection suppliers) { . . . }
    public Collection getSuppliers( ) { . . . }
}
```

```
/**
* Class com.foo.Supplier
*/
package com.foo;
public class Supplier extends Object {
    public String getName( ) { . . . }
    public void setName(String name) { . . . }
    public String getIndustry( ) { . . . }
    public void setIndustry(String industry) { . . . }
    public void setProducts(Collection products) { . . . }
    public Collection getProducts( ) { . . . }
}
```

Assume for each of the classes above that the respective tables t_product and t_supplier are already defined, and that a many-to-many associative table to keep relationship entries has been created by the following statement:

```
CREATE TABLE assoc_supplier_product (
    supplier_name VARCHAR(50),
    product_id INTEGER,
PRIMARY KEY (supplier_name,product_id),
FOREIGN KEY (supplier_name) REFERENCES t_supplier(name),
FOREIGN KEY (product_id) REFERENCES t_product(id));
```

Project mappings for this example are presented below. Note that although not required, it is a common practice to include many-to-many relationship mappings in both ends and declare these as inverse of each other:

```
<?xml version=‘1.0’ encoding=‘utf-8’?>
<!DOCTYPE project SYSTEM ‘cbproject-1.0.dtd’>
<project name=“default ”>
  <class name=“com.foo.Product” primary-table=“t_product”>
    <member name=“id”>
      <attribute data-type=“bigint” column=“t_product.id” key=“true”/>
    </member>
    <member name=“name”>
      <attribute data-type=“varchar” column=“t_product.name”/>
    </member>
    <member name=“price”>
      <attribute data-type=“real” column=“t_product.price”/>
    </member>
    . . .
    <member name=“suppliers”>
      <many-to-many
        target-class=“com.foo.Supplier”
        inverse-of=“products”
        local-key-list=“id”
        target-key-list=“name”
        many-to-many-table=“assoc_supplier_product”
        many-to-many-local-key-list=“productId”
        many-to-many-target-key-list=“supplierName”>
        <many-to-many-key-mapping key=“supplierName”
          column=“assoc_supplier_product.suppliers_name”
        data-type=“varchar” />
        <many-to-many-key-mapping key=“productId”
          column=“assoc_supplier_product.product_id”
        data-type=“bigint” />
      </many-to-many>
    </member>
  </class>
  <class name=“com.foo.Supplier” primary-table=“t_supplier”>
    <member name=“name”>
      <attribute column=“t_supplier.name” data-type=“varchar”
      key=“true”/>
    </member>
    <member name=“industry”>
      <attribute column=“t_supplier.industry” data-type=“varchar”/>
    </member>
    . . .
    <member name=“products”>
      <many-to-many
        target-class=“com.foo.Product”
        inverse-of=“suppliers”
        local-key-list=“name”
        target-key-list=“id”
        many-to-many-table=“assoc_supplier_product”
        many-to-many-local-key-list=“supplierName”
        many-to-many-target-key-list=“productId”>
        <many-to-many-key-mapping key=“supplierName”
          column=“assoc_supplier_product.suppliers_name”
        data-type=“varchar” />
        <many-to-many-key-mapping key=“productId”
          column=“assoc_supplier_product.product_id”
        data-type=“bigint” />
      </many-to-many>
    </member>
  </class>
</project>
```

Note that column data-types defined for many-to-many key mappings must match the data types of referred key columns. For instance, for the com.foo.Supplier mapping above, supplierName maps to a varchar column, which matches the type defined for the column t_supplier.name mapped by the attribute name (referred to as local key by the many-to-many mapping). Also, it is possible to preserve ordering within many-to-many relationships through the many-to-many-order-key element, which in this case should refer to a many-to-many key mapping for the corresponding ordering column in the associative table. Both sides of the relationship can be ordered as long as there's an ordering key column for each participant in the many-to-many relationship.

### 3.2.6. Composite Mapping

A composite member is a member that contains other members within itself. A member that refers to a Java class type, which may in turn contain other mapped members, can be mapped as composite. The XML definition of a composite is the following:

<!ELEMENT composite (member+)>
<!ATTLIST composite class-name CDATA #IMPLIED>

According to the definition above, a composite is nothing but an aggregate of other members. It doesn't specify any mappings to database counterparts. The only available setting is class-name, which is optional and refers to the Java class name that contains other members.

As an example, let us take the class com.foo.Customer below:

```
/**
* Class com.foo.Customer
*/
package com.foo;
public class Customer extends Object {
    public Long getId( ) {...}
    public void setId(Long id) {...}
    public String getName( ) {...}
    public void setName(String name) {...}
    public void setPhone(Phone phone) {...}
    public Phone getPhone( ) {...}
}
```

Now assume the referred class is defined as:

```
/**
* Class com.foo.Phone
*/
package com.foo;
public class Phone extends Object {
    public String getAreaCode( ) {...}
    public void setAreaCode(String areaCode) {...}
    public String getNumber( ) {...}
    public void setNumber(String number) {...}
    public String getExtension( ) {...}
    public void setExtension(String extension) {...}
}
```

Seen from the Java class, a composite member resembles a one-to-one relationship reference. In fact, a composite can be considered a ‘special’ case of a one-to-one relationship. However, before deciding whether a direct reference should be mapped as a composite or as one-to-one member, a few differences in the semantics of composite members must be taken into account:

(a) composite member instances exist only within the context of a containing instance and its life cycle is delimited within the life cycle of that containing instance. For example, let us assume that according to application requirements, an instance of com.foo.Phone can only be loaded from or persisted into the database while attached to an instance of com.foo.Customer. Also, when the customer is removed from the database, its phone data is removed along. A composite is sometimes referred to as an aggregate or dependent object.

(b) a composite member does not need an identity of its own because its identity is actually derived from the identity of the containing instance. That dependency is normally evidenced by the fact that composite sub-members should map to columns defined within the same table used to persist other attribute members of the containing instance, as in table t_customer below:

```
CREATE TABLE t_customer (
    id BIGINT,
    name VARCHAR(50),
    phone_area VARCHAR(5),
    phone_num VARCHAR(10),
    phone_ext VARCHAR(5),
PRIMARY KEY (id));
```

Note that as opposed to the example above composite members may be defined in their own table and may even have an independent primary key (i.e. which is not a foreign key to anything else). But having that primary key column mapped within the composite does not assure uniqueness within the system. That means two identical instances of com.foo.Phone would still be persisted into the database provided they are attached to different customers. In case that may violate a database constraint, then one should consider mapping such member as a one-to-one rather than a composite.

(c) the state of a composite member directly affects the state of its containing instance. For instance, let us say optimistic locking is set for the containing class (e.g. com.foo.Customer). When committing a transaction, the columns mapped within composite members will be also used in the update sql ‘where’ clauses to compare the current state of the object with its actual state in the database. Similarly, in the event of a composite submember has its value changed within a transaction, then the entire containing object is said to be dirty, thus indicating an update is required by the system. That doesn't mean all of the columns referred by that object will be included in the update sql; however, an update instruction will be internally queued for that containing object.

In practical terms, the above means that composite sub-members will be included in the same sql map of the containing instance, that is, members and composite sub-members are all part of the same sql ‘view’ and its values are loaded with one single select instruction to form the object state. One-to-one mappings, on the other hand, assume there are two separate sql maps, one for each class that participates in the relationship. Therefore, participant objects have their state independently managed by the system (i.e. one can be detected as dirty while the other is still clean). Another different is that in a one-to-one member, it is possible to control how operations cascade to the related object, which is not possible with composite members (where operations are invariably propagated to the composite instance).

It is important to observe that in most cases a one-to-one relationship can be mapped as a composite. It is up to the developer to examine application requirements and determine what mapping semantics is required in each case. The following shows how the class com.foo.Customer could be mapped to the table t_customer defined above using composite mapping for its phone information:

```
<?xml version=‘1.0’ encoding=‘utf-8’?>
<!DOCTYPE project SYSTEM ‘cbproject-1.0.dtd’>
<project name=“default”>
  <class name=“com.foo.Customer” primary-table=“t_customer”>
    <member name=“id”>
      <attribute column=“t_customer.id” data-type=“bigint”
      key=“true”/>
    </member>
    <member name=“name”>
      <attribute column=“t_customer.name” data-type=“varchar”/>
    </member>
    <member name=“phone”>
      <composite>
        <member name=“areaCode”>
          <attribute column=“t_customer.phone_area”
          data-type=“varchar”/>
        </member>
        <member name=“number”>
          <attribute column=“t_customer.phone_num”
          data-type=“varchar”/>
        </member>
        <member name=“extension”>
          <attribute column=“t_customer.phone_ext”
          data-type=“varchar”/>
        </member>
      </composite>
    </member>
  </class>
</project>
```

Another important feature regarding the use of composite mappings is that other members can refer to composite sub-members by specifying the full ‘path name’ of that sub-member, as in the example below:

```
<class name=“com.advquickstart.Customer”
primary-table=“t_customer”>
    <member name=“name”>
        <composite>
            <member name=“first”>
                <attribute column=“t_customer.first_name”
                data-type=“varchar” key=“true”/>
            </member>
            <member name=“last”>
                <attribute column=“t_customer.last_name”
                data-type=“varchar” key=“true”/>
            </member>
        </composite>
    </member>
    ...
    <member name=“orders”>
        <one-to-many
            target-class=“com.foo.Order”
            local-key-list=“name.first,name.last”
            target-key-list=“@customerFirstName,
            @customerLastName”
        />
    </member>
</class>
```

The only constraint regarding composite members is that these must be accessible in the Java class, that is, a member mapped as a composite cannot have its access-mode set to none.

### 4. Inheritance Mapping

Just like Java classes, class mappings within a project are organized in a hierarchy of inheritance. Different patterns of inheritance mappings are supported including, but not limited to:
single table inheritance: both class and superclass map to the same table
separate table inheritance: each class has local and inherited members mapping to its own separate table
partitioned table inheritance: each class has its local members mapping to its own table whereas inherited members map to a table defined for the superclass (a table join is required to put local and inherited member partitions all together).

The above inheritance mapping patterns can be combined. Also, table join mappings (explained later) specified within a class map can coexist with the above inheritance patterns without restrictions.

To illustrate inheritance mapping scenarios, let us assume a superclass com.foo.Customer with two subclasses: com.foo.Person (that represents individual customers) and com.foo.Group (that represents a customer group such as a company or office). These Java classes are defined as below:

```
/**
* Class com.foo.Customer
*/
package com.foo;
public class Customer extends Object {
    public Long getId( ) {...}
    public void setId(Long id) {...}
    public String getName( ) {...}
    public void setName(String name) {...}
}
```

```
/**
* Class com.foo.Person
*/
package com.foo;
public class Person extends Customer {
    public Integer getAge( ) {...}
    public void setAge(Integer age) {...}
}
```

```
/**
* Class com.foo.Group
*/
package com.foo;
public class Group extends Customer {
    public String getIndustry( ) {...}
    public void setIndustry(String industry) {...}
}
```

Apart from keeping an id and name for each customer, instances of com.foo.Person also keep the age of those individual customers while instances of com.foo.Group maintain information about each group's industry (e.g. textile, computer software, automobile, etc.).

A subclass-superclass inheritance relationship is specified by including the superclass name into the superclass-list comma-separated string of the given subclass mapping:

<class name=“com.foo.Person” superclass-list=“com.foo.Customer”
primary-table=“t_person”>
...
</class>

The example above shows a class mapping that refers to only one superclass type, although superclass-list can in fact be used to refer to more than one superclass, thus characterizing a multiple inheritance scenario. Multiple inheritance mapping is discussed in more detail later in this document.

An important feature of the inheritance mapping approach adopted here is that the system can automatically infer which mapping pattern is being used for representing inheritance based on how attribute members map to table columns. There is no need for the developer to specify in advance which inheritance mapping pattern is being applied. When a class and its members are properly mapped, the only additional requirement for proper inheritance mapping is that a discriminator attribute is specified as part of the mappings that describe the subclass-superclass inheritance relationship. The mapping of discriminator attributes is discussed next.

### 4.1. Discriminator Mapping

The main purpose of a discriminator is to distinguish an instance of a subclass when a query is performed at one of its superclasses. Such polymorphic queries return instances that are created and populated according to the selected data entries. In order to create these instances, the system must decide which class to instantiate for each data entry (i.e. table row). By comparing the data mapped by the discriminator against a given value, the system can determine which class needs to be instantiated and populated from that particular entry.

The discriminator element is defined as follows:

<!ELEMENT discriminator EMPTY>

| (1) | <!ATTLIST discriminator name CDATA #REQUIRED> |
|---|---|
| (2) | <!ATTLIST discriminator negated (true \| false) “false”> |
| (3) | <!ATTLIST discriminator compare-function ( equals \| less-than \| |
| | greater-than \| contains \| starts-with \| ends-with) “equals”> |
| (4) | <!ATTLIST discriminator value CDATA #REQUIRED> |
| (1) | name: specifies the name of the attribute member to be used as |
| | discriminator. |
| (2) | negated: indicates that the compare function used to compare the |
| | discriminator should be negated. |
| (3) | compare-function: the compare function used to compare the |
| | discriminator to the value that is provided. When the result of this |
| | comparison is true then the entry is assumed to be an instance |
| | of the subclass in question. |
| (4) | value: the value the discriminator must be compared to. |

Note that the discriminator name must refer to a member that is mapped as an attribute. For example, the attribute member age could be referred to as being the discriminator of class com.foo.Person:

```
<class name=“com.foo.Person” superclass-list=“com.foo.Customer”
primary-table=“t_person”>
    <default-inheritance>
        <discriminator name=“age” compare-function=“greater-than”
        value=“0”/>
    </default-inheritance>
    ...
    <member name=“age”>
        <attribute column=“t_person.age” data-type=“integer”/>
    </member>
    ...
</class>
```

In this example, an entry is recognized as being an instance of com.foo.Person when the value of age (mapped to column t_person.age) is greater than zero. Discriminator mappings are usually nested within the default-inheritance mapping element (discussed later).

As an example on how the system handles discriminator mappings, assume the following data entries:

| id | name | age | street | num | zip |
|---|---|---|---|---|---|
| 01 | ‘John’ | 40 | ‘Main’ | 360 | ‘65104’ |
| 02 | ‘ACME’ | null | ‘Filbert’ | 1971 | ‘94123’ |
| 03 | ‘Rose’ | 25 | ‘Van Ness’ | 3015 | ‘94105’ |

According to the discriminator mapping above, entries 01 and 03 will be discriminated as instances of com.foo.Person. Entry 02 is not discriminated that way because the discriminator comparison expression (tperson.age>0) doesn't evaluate to true for such entry.

Let's now assume com.foo.Local is a subclass of com.foo.Person:

/**
* Class com.foo.Local
*/
package com.foo;
public class Local extends Person {
...
}

Class com.foo.Local has no Java members apart from those inherited from com.foo.Person and it has the only purpose of representing customers that live in a local area. Let's say an instance of com.foo.Local can be discriminated by the fact that its zip code starts with prefix ‘94’, which is mapped this way:

```
<class name=“com.foo.Local” superclass-list=“com.foo.Person”
primary-table=“t_person”>
  <default-inheritance>
    <discriminator name=“zip” compare-function=“starts-with”
    value=“‘94’”/>
  </default-inheritance>
</class>
```

The mapping above seems to suffice in order to discriminate com.foo.Local instances. But this is how the data entries listed above would end up being discriminated when a query is performed against com.foo.Customer:

| id | name | age | street | num | zip |
|---|---|---|---|---|---|
| 01 | ‘John’ | 40 | ‘Main’ | 360 | ‘65104’ -> com.foo.Person |
| 02 | ‘ACME’ | null | ‘Filbert’ | 1971 | ‘94123’ -> com.foo.Local |
| 03 | ‘Rose’ | 25 | ‘Van Ness’ | 3015 | ‘94105’ -> com.foo.Local |

Note that ‘ACME’ is instantiated as a comfoo.Local even though its age is null (which would not qualify it as a com.foo.Person according to the discriminator defined for it). In order to understand why that occurs, it is important to know how the system default instance factory processes discriminators across a class mapping hierarchy when polymorphic queries take place. What happens is that, as a query is performed against a given superclass, discriminators are evaluated against data entries in a subclass to superclass order, starting from leafsubclasses. Then, as discriminator mappings of a given subclass evaluate to true for the data entry being processed, an instance of that subclass is created out of that data entry, and processing moves on to the next entry. In the event that entry could not be discriminated by any of the subclasses, an instance of the superclass being queried against is created from that entry.

So, in the previous example, com.foo.Local is the leaf subclass, and data entries are first matched against its discriminator. As entry 02 (i.e. ‘ACME’) holds a zip code that evaluates to true for that disciminator, it is instantiated as a com.foo.Local. One may say this is not the expected result as it conflicts with the discriminator mappings defined for com.foo.Person, which assert that the age of a person cannot be null. Besides, since com.foo.Local instances are also instances of com.foo.Person, entry 02 cannot be discriminated as such. That's a typical situation where one single discriminator is not sufficient to have an instance of the subclass properly discriminated. In that case, multiple inheritance discriminators can be specified. The solution in this example would be to simply repeat the superclass discrimination rule (i.e. that a person must have an age greater than zero) within com.foo.Local mappings. For example:

```
<class name=“com.foo.Local” superclass-list=“com.foo.Person”
primary-table=“t_person”>
  <default-inheritance>
    <discriminator name=“age” compare-function=“greater-than”
    value=“0”/>
    <discriminator name=“zip” compare-function=“starts-with”
    value=“‘94’”/>
  </default-inheritance>
</class>
```

Multiple discriminators are evaluated with and logic, meaning that all discriminator mappings must evaluate to true in order for the entry to be recognized as an instance of the discriminated subclass. So, discriminator mappings defined as above would prevent ‘ACME’ from being discriminated as either a com.foo.Local or com.foo.Person instance, and the system would end up instantiating it as a com.foo.Customer, thus giving the expected classification.

The attribute referred by the discriminator is not required to exist in the class being discriminated. That is often the recommended approach as it allows discrimination to be independent from application data contents. Assume, for instance, that data entries include a discriminator column called type, which contains a ‘short’ name of the class to be instantiated:

| id | name | age | type |
|---|---|---|---|
| 01 | ‘John’ | 40 | ‘Person’ |
| 02 | ‘ACME’ | null | ‘Company’ |
| 03 | ‘Rose’ | 25 | ‘Person’ |

This special type column is not supposed to be mapped as an actual attribute of any of the referred Java classes. It is just a column with the purpose to discriminate table entries. In this case, the discriminator can refer to a virtual attribute mapping (i.e. its member access mode is set to none), as in the example below:

```
<class name=“com.foo.Person” superclass-list=“com.foo.Customer”
primary-table=“t_person”>
  <default-inheritance>
    <discriminator name=“@type” value=“‘Person’”/>
  </default-inheritance>
  ...
  <member name=“@type” access-mode=“none”>
    <attribute column=“t_customer.type” data-type=“varchar”/>
  </member>
  ...
</class>
```

Note that compare-function was omitted from the mappings above as it defaults to equals. Inheritance discriminator defined this way may have a particular impact while inserting instances of the class being mapped. More specifically, whenever a discriminator referring to a virtual attribute is mapped within default-inheritance and it is being compared to the discrimination value by the “equals” compare function, the system will assume that the discrimination value is an immutable constant that should be stored along with instance data to indicate its ‘type’. As a result, runtime generated sql insert statements will have the discrimination value hard-coded for the corresponding discrimination column. This mechanism is very useful to assure discriminators are transparently maintained by the system so that the application does not have to deal with such mapping directly within its code. That might not apply if a sql map for the mapped class is pre-compiled and modified at design time (pre-compiled sql maps and its usage are out of the scope of this document).

### 4.2. Default and Subclass Inheritance Mappings

There's two alternative ways of specifying a discriminator for inheritance hierarchies. The most common one is to specify it within the default-inheritance mapping (such as in the examples above).

The default inheritance mapping element must be specified as part of the class mapping for the subclass in question, and it applies to all of the (direct or indirect) superclasses as a default way to identity instances of that subclass. Each class mapping can specify at most one default-inheritance mapping. The XML definition of a class default-inheritance mapping is the following:

```
<!ELEMENT default-inheritance (discriminator+)>
  <!ATTLIST default-inheritance mode (auto | disjoint | overlapping)
  “auto”>
```

The default-inheritance element can contain one or multiple discriminator entries. It is also possible to specify a mode for it. The inheritance mode only applies when subclass and superclass map to different tables (e.g. partitioned or separate table inheritance). It is sort of a hint when it is not clear to the system whether a join between both subclass and superclass tables needs to be performed in the event of a query against that class hierarchy. As the system is likely capable of inferring the correct sql that should be generated for the classes that participate in the hierarchy, mode is usually left unspecified (i.e. set to auto). Otherwise, the developer can specify whether tables are disjoint (i.e. no join required) or overlapping (i.e. join required) across the inheritance hierarchy.

The other alternative is to have it specified within the subclass-inheritance mapping element that goes within the class mapping of the superclass:

<!ELEMENT subclass-inheritance (discriminator+)>
(1) <!ATTLIST subclass-inheritance subclass CDATA #REQUIRED>
(2) <!ATTLIST subclass-inheritance mode (auto | disjoint | overlapping)
“auto”>

| | |
|---|---|
| (1) | subclass: refers to the subclass being discriminated. |
| (2) | mode: meaningful only when the subclass maps to a different table. |
| | Indicates whether a join between tables is required to restrict the |
| | instance set (i.e. when tables are overlapping) or not |
| | (i.e. when tables are disjoint). |

A class mapping can contain multiple subclass-inheritance mappings, one for each subclass. For example:

```
<class name=“com.foo.Customer” primary-table=“t_customer”>
  <subclass-inheritance subclass=“com.foo.Person”>
    <discriminator name=“age” compare-function=“equals”
    value=“null” negated=“true”/>
  </subclass-inheritance>
  <subclass-inheritance subclass=“com.foo.Group”>
    <discriminator name=“industry” value=“null” negated=“true”/>
  </subclass-inheritance>
  ...
</class>
<class name=“com.foo.Person” superclass-list=“com.foo.Customer”
primary-table=“t_person”>
  ...
  <member name=“age”>
    <attribute column=“t_person.age” data-type=“integer”/>
  </member>
  ...
</class>
<class name=“com.foo.Group” superclass-list=“com.foo.Customer”
primary-table=“t_group”>
  ...
  <member name=“industry”>
    <attribute column=“t_group.industry” data-type=“varchar”/>
  </member>
  ...
</class>
```

Subclass inheritance mappings override any default-inheritance mappings present in respective subclass mappings and may be particularly useful when dealing with multiple inheritance scenarios where a superclass needs a different way of discriminating its subclass instances. However, such mappings are only taken into account when a query is performed against that particular superclass. In the example above, if a query is performed against com.foo.Customer, any default inheritance discriminators in its subclasses will be disregarded and its subclass inheritance discriminators will be used instead. That means the default discriminator that says that a person must have an age greater than zero in this case was overridden by the discrimination where person's age is not (i.e. negated=“true”) equal to null. But note that the default-inheritance mappings of subclasses may still hold when queries are performed against other possibly existing (direct or indirect) superclasses.

More formally, let a query be performed against a superclass C, and let d be a discrimination value returned as part of the selected data entry being processed. This is how the system would evaluate discriminator mappings in order to instantiate an object from that data entry:

1. for each direct or indirect subclass S(leaf first) of C
2. if exists a subclass inheritance mapping for Cwhere subclass=S then
3. evaluate each discriminator defined for subclass S by comparing its value against d
4. if all discriminators evaluate to true, then instantiate S and populate it with selected data
5. else if a default inheritance discriminator exists for S
6. evaluate each default discriminator defined in S by comparing its value against d
7. if all discriminators evaluate to true, then instantiate S and populate it with selected data
8. end if
9. end for
10. if no instance was created, then instantiate C and populate it with selected data

The last line above simply says that when a query is performed against a superclass C and the selected data cannot be discriminated, the system will create an instance of C out of the data being processed.

Overall, having discriminator mappings for subclasses is a fundamental requirement for polymorphic queries when mapping inheritance, be those either mapped at the superclass mapping within subclass-inheritance elements or directly at the subclass mapping itself within a default-inheritance mapping. However, having a default-inheritance mapping for the subclass is usually the recommended approach, not only because it prevents all direct and indirect superclass mappings from having to include a subclass-inheritance mapping for that subclass, but also because it can be used to inform the runtime to transparently manage discriminator columns upon insertion (see above). Besides, as it shall be discussed next, default-inheritance mappings are required for proper mapping of single table inheritance scenarios.

### 4.3. Single Table Inheritance Mapping

Single table inheritance occurs when both class and superclass map to the same table. This can be verified when the primary table is the same in both subclass and superclass mappings and attribute members in common map to the exact same columns.

Assume a table t_customer defined as below:

```
CREATE TABLE t_customer (
    id BIGINT,
    name VARCHAR(50),
    age INTEGER,
    industry VARCHAR,
    type VARCHAR(20),
PRIMARY KEY (id));
```

Entries in this table would look the following:

| Id | name | age | industry | type |
|---|---|---|---|---|
| 01 | ‘John’ | 40 | null | ‘Person’ |
| 02 | ‘ACME’ | null | ‘textile’ | ‘Group’ |
| 03 | ‘Rose’ | 25 | null | ‘Person’ |

The above scenario would be mapped as below:

```
<?xml version=“1.0” encoding=“UTF-8”?>
<!DOCTYPE project SYSTEM ‘cbproject-1.0.dtd’>
<project name=“default”>
  <class name=“com.foo.Customer” primary-table=“t_customer”>
    <member name=“id”>
      <attribute column=“t_customer.id” data-type=“bigint”
      key=“true”/>
    </member>
    <member name=“name”>
      <attribute column=“t_customer.name” data-type=“varchar”/>
    </member>
    <member name=“@type” access-mode=“none”>
      <attribute column=“t_customer.type” data-type=“varchar”/>
    </member>
  </class>
  <class name=“com.foo.Person”
      superclass-list=“com.foo.Customer”
      primary-table=“t_customer”
  >
    <default-inheritance>
      <discriminator name=“@type” value=“‘Person’”/>
    </default-inheritance>
    <member name=“id”>
      <attribute column=“t_customer.id ” data-type=“bigint”/>
    </member>
    <member name=“name”>
      <attribute column=“t_customer.name” data-type=“varchar”/>
    </member>
    <member name=“age”>
      <attribute column=“t_customer.age” data-type=“integer”/>
    </member>
    <member name=“@type”>
      <attribute column=“t_customer.type” data-type=“varchar”/>
    </member>
  </class>
  <class name=“com.foo.Group”
      superclass-list=“com.foo.Customer”
      primary-table=“t_customer”
  >
    <default-inheritance>
      <discriminator name=“@type” value=“‘Group’”/>
    </default-inheritance>
    <member name=“id”>
      <attribute column=“t_customer.id” data-type=“bigint”/>
    </member>
    <member name=“name”>
      <attribute columm=“t_customer.name” data-type=“varchar”/>
    </member>
    <member name=“industry”>
      <attribute column=“t_customer.industry” data-type=“varchar”/>
    </member>
    <member name=“@type”>
      <attribute column=“t_customer.type” data-type=“varchar”/>
    </member>
  </class>
</project>
```

A few important remarks need to be made about this example. In subclass mappings, even though members are inherited, attribute column mappings must be specified, or the system will assume that the attribute is unmapped in that subclass. For example, in the mapping above, the subclass column mappings for name replicate the mapping defined in the superclass com.foo.Customer (i.e. column=“t_customer.name”). If omitted, name would then be assumed to be an attribute member where column mappings are missing thus causing the entire subclass mapping to be incomplete. In other words, a class mapping must contain proper mappings for each persistent attribute, be it local or inherited. The same requirement applies to sub-members of a composite. On the other hand, the definition of key attribute member (i.e. where key=“true”) must occur only once at the uppermost superclass and cannot be overridden by subclasses.

According to the mappings presented above, query against com.foo.Customer would properly discriminate its data entries based on the value of the column t_customer.type.

But when a query is performed against a subclass that shares the same primary table with its superclass, things are handled a little bit different. Instead of performing a ‘blind’ selection against the superclass table, and then discriminating instances of the subclass, the runtime simply add where conditions for the default inheritance discriminators defined for that subclass. In this case, a query against com.foo.Person would produce a sql equivalent to the following:

select id, name, age from t_customer where [...other conditions and]
type = ‘Person’

That is a very important optimization as only the columns and rows specific to com.foo.Person will be retrieved. Note this is only possible because the discriminators for com.foo.Person are specified within a default-inheritance mapping element. Otherwise, the runtime system would not have enough information to restrict data rows this way for queries performed at the subclass level. So, in other words, having discriminators mapped within default-inheritance for each subclass is a requirement in single table inheritance mapping scenarios, or the system will not be able to properly restrict queries against subclasses.

### 4.4. Partitioned Table Inheritance Mapping

In partitioned table inheritance, subclass and superclass each map to different tables, where tables include only the columns for attributes defined locally. From a subclass perspective, each table corresponds to a vertical partition of the object and a table join is required to put the columns all together. For example, consider the following tables have been defined:

```
CREATE TABLE t_customer (
    id BIGINT,
    name VARCHAR(50),
    type VARCHAR(20),
PRIMARY KEY (id));
```

```
CREATE TABLE t_person (
    id BIGINT,
    age INTEGER,
PRIMARY KEY (id),
FOREIGN KEY (id) REFERENCES t_customer(id));
```

```
CREATE TABLE t_group (
    id BIGINT,
    industry VARCHAR,
PRIMARY KEY (id),
FOREIGN KEY (id) REFERENCES t_customer(id));
```

The foreign and primary key constraints are not required. However, it is a requirement that entries in the subclass table refer to the respective entry in the superclass table so that the join between these tables can properly reconstitute the object data. This is an example of how tables above would be populated in partitioned table inheritance:

t_customer:

| id | name | type |
|---|---|---|
| 01 | ‘John’ | ‘Person’ |
| 02 | ‘ACME.’ | ‘Group’ |
| 03 | ‘Rose’ | ‘Person’ |

t_person:

| id | age |
|---|---|
| 01 | 40 |
| 03 | 25 |

t_group:

| id | industry |
|---|---|
| 02 | ‘textile’ |

Entries relate to each other by the id column, which also identifies the entry. Specifying mappings for the above scenario is relatively simple. First, let the class mapping of the subclass replicate all inherited attribute member mappings defined in the referred superclass mapping, except key attribute member mappings, which must map to columns in the primary table (note that at all cases, not only inheritance, key attributes must map to columns in the primary table or mappings will be invalid). Then, let it also define attribute mappings for local members so that these map to columns in the primary table (although this is not a requirement). According to these steps, this is how mappings could be specified:

<?xml. version=″1 .0″ encoding=″UTF-8″?>
<!DOCTYPE project SYSTEM ′cbproject-1.0.dtd′>
<project name=″default″>

<class name=″com.foo.customer″primary-table=″t_customer″>

<member name=″id″>

<attribute column=″t_customer.id″ data-type=″bigint″ key=″true″/>

</member>
<member name=″name″>

<attribute column=″t_customer.name″ data-type=″varchar″/>

</member>
<member name=″@type″ access-mode=″none″>

<attribute column=″t_customer.type″ data-type=″varchar″/>

</member>

<class>

<class name=″com.foo.Person″

superclass-list=″com.foo.Customer″
primary-table=″t_person″

>

<default-inheritance>

<discriminator name=″@type″ value=″Person′″/>

</default-inheritance>
<member mame=″id″>

<attribute columm=″t_person.id″ data-type=″bigint″/>

</member>
<member name=″name″>

<attribute column=″t_customer.name″ data-type=″varchar″/>

</member>
<member name=″age″>

<attribute column=″t_person.age″ data-type=″integer″/>

</member>
<member name=″@type″>

<attribute column=″t_customer.type″ data-type=″varchar″/>

</member>

</class>
<class name=″com.foo.Group″

superclass-list=″com.foo.Customer″
primary-table=″t_group″

>

<default-inheritance>

<discriminator name=″@type″ value=″′Group′″/>

</default-inheritance>
<member mame=″id″>

<attribute column=″t_group.id″ data-type=″bigint″/>

</member>
<member name=″name″>

<attribute column=″t_customer.name″ data-type=″varchar″/>

</member>
<member name=″industry″>

<attribute column=″t_group.industry″ data-type=″varchar″/>

</member>
<member name=″@type″>

<attribute column=″t_customer.type″ data-type=″varchar″/>

</member>

</class>
</project>

The mappings above specify discriminators within default-inheritance mappings of each subclass, but subclass-inheritance mappings in customer for each subclass could also have been used instead. That is so because a default inheritance mapping discriminator is not required for subclasses in partitioned table inheritance as superclass instances are instantly filtered out by the table join when selecting directly against the subclass. For example, this would be the equivalent sql generated for a query against com.foo.Person:

select t_person.id, t_customer name, t_person.age from
t_person, t_customer
where (t_person.id = t_customer.id) [and ...other conditions]

A query against the superclass, on the other hand, will perform an outer join so that data from subclass tables is included in the result data, as in the sql below:

```
select t_customer.id, t_customer name, t_person.age,
t_group.industry, t_customer.type
            from t_customer
            left join t_person on t_customer.id = t_person.id
            left join t_group on t_customer.id = t_group.id
[where ...conditions]
```

Note the discriminator column is included in this case so that selected data entries can be properly discriminated.

### 4.5. Separate Table Inheritance Mapping

In separate table inheritance, both subclass and superclass map to separate tables, where each table contains the columns for all attributes in the corresponding class. For example, assume the tables defined as follows:

```
CREATE TABLE t_customer (
    id BIGINT,
    name VARCHAR(50),
PRIMARY KEY (id));
```

```
CREATE TABLE t_person (
    id BIGINT,
    name VARCHAR(50),
    age INTEGER,
PRIMARY KEY (id));
```

```
CREATE TABLE t_group (
    id BIGINT,
    name VARCHAR(50),
    industry VARCHAR,
PRIMARY KEY (id));
```

A separate table inheritance mapping scenario is mainly characterized by the fact that the primary tables are disjoint, that is, whenever a join between both tables is performed on the key columns (assume id is the key column for the example above) the result set is empty. Also, both local and inherited attributes map to columns defined within that same table (even though that is not a requirement). This would be one acceptable way to have the above tables populated:

t_customer:

| id | name |
|---|---|
| 99 | ‘Unknown’ |

t_person:

| id | name | age |
|---|---|---|
| 01 | ‘John’ | 40 |
| 03 | ‘Rose’ | 25 |

t_group:

| id | name | industry |
|---|---|---|
| 02 | ‘ACME’ | ‘texttile’ |

Considering the tables above, this is how the mappings could be specified:

```
<?xml version=“1.0” encoding=“UTF-8”?>
<!DOCTYPE project SYSTEM ‘cbproject-1.0.dtd’>
<project name=“default”>
  <class name=“com.foo.Customer” primary-table=“t_customer”>
    <member name=“id”>
      <attribute column=“t_customer.id” data-type=“bigint”
      key=“true”/>
    </member>
    <member name=“name”>
      <attribute column=“t_customer.name” data-type=“varchar”/>
    </member>
  </class>
  <class name=“com.foo.Person”
      superclass-list=“com.foo.Customer”
      primary-table=“t_person”
  >
    <default-inheritance>
      <discriminator name=“age” value=“null” negated=“true”/>
    </default-inheritance>
    <member name=“id”>
      <attribute column=“t_person.id” data-type=“bigint”/>
    </member>
    <member name=“name”>
      <attribute column=“t_person.name” data-type=“varchar”/>
    </member>
    <member name=“age”>
      <attribute column=“t_person.age” data-type=“integer”/>
    </member>
  </class>
  <class name=“com.foo.Group”
      superclass-list=“com.foo.Customer”
      primary-table=“t_group”
  >
    <default-inheritance>
      <discriminator name=“industry” value=“null” negated=“true”/>
    </default-inheritance>
    <member name=“id”>
      <attribute column=“t_group.id” data-type=“bigint”/>
    </member>
    <member name=“name”>
      <attribute column=“t_group.name” data-type=“varchar”/>
    </member>
    <member name=“industry”>
      <attribute column=“t_group.industry” data-type=“varchar”/>
    </member>
  </class>
</project>
```

Note that there is no additional settings that indicate this is a separate table inheritance scenario or that is a partitioned table scenario, which simplifies a great deal the mapping of inheritance scenarios like this. All the developer has to worry about is to indicate where the object data can be found (i.e. in which table and column) for each of the attribute members and the system will manage to generate the correct sql for querying and persisting that data. Note also that due to the lack of a specific discriminator column, subclasses were discriminated based on their local attributes. For example, com.foo.Person discriminator mapping says that t_person.age cannot be null. The same strategy was used for com.foo.Group, where its discriminator mapping says that t_group.industry cannot be null. That works well for the table entries above.

Now let us assume t_person contains an entry where the value of age is null:

t_person:

| id | name | age |
|---|---|---|
| 01 | ‘John’ | 40 |
| 03 | ‘Rose’ | null |

That does not mean entry 03 should not be discriminated as a com.foo.Person. Indeed it should, considering all entries in t_person should be discriminated as such. Perhaps it is just the case that the value of age has never been informed. For cases where it is not possible to rely on existing columns, it is possible to specify a hard-coded discrimination value for each of the classes, which is used to distinguish entries. This is only possible in separate inheritance scenarios due to data entries come from different tables. The mappings below exemplify this strategy:

```
<?xml version=“1.0” encoding=“UTF-8”?>
<!DOCTYPE project SYSTEM ‘cbproject-1.0.dtd’>
<project name=“default”>
  <class name=“com.foo.Customer” primary-table=“t_customer”>
    <default-inheritance>
      <discriminator name=“@disc” value=“‘CUSTOMER’”/>
    </default-inheritance>
    <member name=“id”>
      <attribute column=“t_customer.id” data-type=“bigint”
      key=“true”/>
    </member>
    <member name=“name”>
      <attribute column=“t_customer.name” data-type=“varchar”/>
    </member>
    <member name=“@disc” access-mode=“none”>
      <attribute data-type=“varchar”/>
    </member>
  </class>
  <class name=“com.foo.Person”
      superclass-list=“com.foo.Customer”
      primary-table=“t_person”
  >
    <default-inheritance>
      <discriminator name=“@disc” value=“PERSON’”/>
    </default-inheritance>
    <member name=“id”>
      <attribute column=“t_person.id” data-type=“bigint”/>
    </member>
    <member name=“name”>
      <attribute column=“t_person.name” data-type=“varchar”/>
    </member>
    <member name=“age”>
      <attribute column=“t_person.age” data-type=“integer”/>
    </member>
  </class>
  <class name=“com.foo.Group”
      superclass-list=“com.foo.Customer”
      primary-table=“t_group”
  >
    <default-inheritance>
      <discriminator name=“@disc” value=“‘GROUP’”/>
    </default-inheritance>
    <member name=“id”>
      <attribute column=“t_group.id” data-type=“bigint”/>
    </member>
    <member name=“name”>
      <attribute column=“t_group.name” data-type=“varchar”/>
    </member>
    <member name=“industry”>
      <attribute column=“t_group.industry” data-type=“varchar”/>
    </member>
  </class>
</project>
```

Default inheritance mappings above include a discriminator that refers to an attribute mapping called @disc (it could have been called any other name not already in use by other members). What makes the systems assume this is a special discrimination attribute is the fact that its access mode is set to none (i.e. its virtual combined with the fact that it does not map to any table columns (i.e. an unmapped attribute). The system will detect that situation and will include such discriminator attribute member as part of the selected entries using the hard-coded value defined in the discriminator mappings. For the example above, this is how entries would look like when selecting against com.foo.Customer:

| id | name | age | industry | disc |
|---|---|---|---|---|
| 99 | ‘Unknwon’ | null | null | ‘CUSTOMER’ |
| 01 | ‘John’ | 40 | null | ‘PERSON’ |
| 03 | ‘Rose’ | null | null | ‘PERSON’ |
| 02 | ‘ACME’ | null | ‘textile’ | ‘GROUP’ |

The above entries are collected all together by a sql union operation against the tables in question and then discriminated based on the hard-coded discrimination values. Unmapped attributes can also be used as helpers in other complex inheritance mapping scenarios not discussed in this document.

### 4.6. Multiple Inheritance Mapping

A Java class can have only one superclass from which it inherits fields and method implementations. That is why Java is said to only support single inheritance. However, Java supports multiple type inheritance if one thinks in terms of Java types (i.e. classes and interfaces) because a subtype (class or interface) can implement multiple interfaces. From the object-to-relational mapping perspective, what is being mapped is in fact the Java type rather than the code with its class implementation, so it makes sense to consider multiple inheritance as a valid mapping scenario.

For example, assume com.foo.Group is defined as below:

```
/**
* Class com.foo.Group
*/
package com.foo;
public class Group extends Customer implements Company {
    public String getIndustry( ) { . . . }
    public void setIndustry(String industry) { . . . }
}
```

The difference from its original definition is that now com.foo.Person also implements com.foo.Company, a Java interface which is defined as follows:

```
/**
* Interface com.foo.Company
*/
package com.foo;
public interface Company {
    public Long getId( ) { . . . }
    public void setId(Long id) { . . . }
    public String getIndustry( );
    public void setIndustry(String industry);
}
```

What is important in a scenario like this is that polimorphic queries including instances of com.foo.Person can not only be performed against its Java superclass com.foo.Customer, but also against com.foo.Company. Just to illustrate this scenario, let us assume tables are now organized as below:

```
CREATE TABLE t_customer (
    id BIGINT,
    name VARCHAR(50),
    type VARCHAR(20),
PRIMARY KEY (id));
```

```
CREATE TABLE t_person (
    id BIGINT,
    age INTEGER,
PRIMARY KEY (id));
```

```
CREATE TABLE t_company (
    id BIGINT,
    industry VARCHAR(50),
PRIMARY KEY (id));
```

In this example, the column industry is now defined on table t_company and the original table t_group is no longer required. Tables would be populated as below:

t_customer:

| id | name | type |
|---|---|---|
| 01 | ‘John’ | ‘Person’ |
| 02 | ‘ACME.’ | ‘Group’ |
| 03 | ‘Rose’ | ‘Person’ |

t_person:

| id | age |
|---|---|
| 01 | 40 |
| 03 | 25 |

t_company:

| id | industry |
|---|---|
| 02 | ‘textile’ |
| 11 | ‘barn supplies’ |
| 12 | ‘wing co.’ |

As one can see, not all company entries represent actual customer groups. Entries 11 and 12 are just company instances, most likely from other classes (now included in this example) that implement com.foo.Company besides com.foo.Group. According to this table scenario, this is how mappings could be specified for the corresponding classes:

```
<?xml version=“1.0” encoding=“UTF-8”?>
<!DOCTYPE project SYSTEM ‘cbproject-1.0.dtd’>
<project name=“default”>
  <class name=“com.foo.Customer” primary-table=“t_customer”>
    <member name=“id”>
      <attribute column=“t_customer.id” data-type=“bigint”
      key=“true”/>
    </member>
    <member name=“name”>
      <attribute column=“t_customer.name” data-type=“varchar”/>
    </member>
    <member name=“@type” access-mode=“none”>
      <attribute column=“t_customer.type” data-type=“varchar”/>
    </member>
  </class>
  <class name=“com.foo.Person”
      superclass-list=“com.foo.Customer”
      primary-table=“t_person”
  >
    <default-inheritance>
      <discriminator name=“@type” value=“‘Person’”/>
    </default-inheritance>
    <member name=“id”>
      <attribute column=“t_person.id” data-type=“bigint”/>
    </member>
    <member name=“name”>
      <attribute column=“t_customer.name” data-type=“varchar”/>
    </member>
    <member name=“age”>
      <attribute column=“t_person.age” data-type=“integer”/>
    </member>
    <member name=“@type”>
      <attribute column=“t_customer.type” data-type=“varchar”/>
    </member>
  </class>
  <class name=“com.foo.Group”
      superclass-list=“com.foo.Customer,com.foo.Company”
      primary-table=“t_customer”
  >
    <default-inheritance>
      <discriminator name=“@type” value=“‘Group’”/>
    </default-inheritance>
    <member name=“id”>
      <attribute column=“t_customer.id” data-type=“bigint”/>
    </member>
    <member name=“name”>
      <attribute column=“t_customer.name” data-type=“varchar”/>
    </member>
    <member name=“industry”>
      <attribute column=“t_company.industry” data-type=“varchar”/>
    </member>
    <member name=“@type”>
      <attribute column=“t_customer.type” data-type=“varchar”/>
    </member>
  </class>
  <class name=“com.foo.Company” abstract=“true”
  primary-table=“t_company”>
    <member name=“id”>
      <attribute column=“t_company.id” data-type=“bigint”
      key=“true”/>
    </member>
    <member name=“industry”>
      <attribute column=“t_company.industry” data-type=“varchar”/>
    </member>
  </class>
</project>
```

Note that superclass-list in com.foo.Group now includes also com.foo.Company. Also, its primary table was set to t_customer, but setting it to t_company would also have worked (the only difference would be that the key attribute id mapping would have to map to t_company.id instead). Note also that com.foo.Company mapping has abstract set to true. This is to prevent the runtime from generating insert, update or delete sql for that class. Since it cannot have direct instances, it doesn't make sense to have sql to insert, update or delete those instances.

Multiple inheritance scenarios usually combine inheritance mapping patterns discussed earlier. In this example, com.foo.Group combines single table inheritance (from com.foo.Customer) with partitioned table inheritance (from com.foo.Company). Such combination usually reflects in the generated sql. For instance, a query against com.foo.Group now also performs a join with t_company so that it can collect the values for the column industry. Below is an approximation of the generated sql for a query against com.foo.Person:

select t_customer.id, t_customer.name, t_company.industry
from t_customer, t_company
where ((t_customer.id = t_company.id) and t_customer.type = Group’)
[and ...other conditions]

The sql generated for polymorphic queries against either com.foo.Customer or com.foo.Company is rather complex and not shown here, but it is generated in a way to assure that only the necessary row form either class and respective subclasses are selected.

### 5. Advanced Mapping Features

### 5.1. Table Join Mapping

In some databases, especially legacy ones, data that usually could be organized into one single table may be partitioned in several tables. So, in order to collect the data about an object all together, it is necessary to perform joins across those tables.

Table join mappings not only specify how tables should be joined while collecting data, but also how data must be stored across those tables. Join mappings are specified by the join mapping element, defined like:

```
<!ELEMENT join (join-key*,join-expression?)>
  (1)  <!ATTLIST join type (inner | left ) “left”>
  (2)  <!ATTLIST join table CDATA #REQUIRED>
```

| | |
|---|---|
| (1) | type: indicate whether this is a left or an inner join. |
| (2) | table: the name of the table being joined. |

The join element contains one or more join keys, which refer to attributes mapping the columns used to restrict the join. The join-key mapping element is described below:

| | <!ELEMENT join-key EMPTY> |
|---|---|
| | (1) <!ATTLIST join-key name CDATA #REQUIRED> |
| | (2) <!ATTLIST join-key column CDATA #REQUIRED> |
| | (3) <!ATTLIST join-key data-type CDATA #IMPLIED> |
| | (4) <!ATTLIST join-key db-type CDATA #IMPLIED> |
| | (5) <!ATTLIST join-key size CDATA #IMPLIED> |
| | (6) <!ATTLIST join-key searchable (true \| false) #IMPLIED> |
| | (7) <!ATTLIST join-key signed (true \| false) #IMPLIED> |
| (1) | name: the name of the attribute member mapping to the column |
| | the join is performed on. |
| (2) | column: the column in the join table that contains the data matching |
| | the join key attribute column. |
| (3) | data-type: the data type used to load or store the value for the join |
| | table column. Internally, this determines the jdbc type the system will |
| | use obtain or modify the data. Available data-types are: bit, tinyint, |
| | smallint, integer, bigint, real, float, double, numeric, decimal, char, |
| | varchar, longvarchar, date, time, timestamp, binary, varbinary, |
| | longvarbinary, java-object, distinct, struct, array, blob, clob, ref, |
| | null, other, calendar and its correspondence to Java types is the |
| | same as that given by the jdbc specification. |
| (4) | db-type: a string that describes how the given data type is represented |
| | in the target database. This is an optional attribute and its value can |
| | be obtained automatically by the system. |
| (5) | size: a string indicating the size (in length) used by the join table |
| | column to store the data. This is an optional attribute and its value |
| | can be automatically inferred by the system. |
| (6) | searchable: indicates whether the target database supports search |
| | expressions on the join table column or not. This is an optional |
| | attribute and its value can be automatically inferred by the system. |
| (7) | signed: indicates whether the join table column maps to signed values |
| | or not. This is an optional attribute and its value can be automatically |
| | inferred by the system. |

As an example, let us assume class com.foo.Product defined as follows:

```
/**
* Class com.foo.Product
*/
package com.foo;
    public class Product extends Object {
    public Long getId( )  { . . . }
    public void setId(Long id)  { . . . }
    public String getName( )  { . . . }
    public void setName(String name)  { . . . }
    public Float getPrice( )  { . . . }
    public void setPrice(Float price)  { . . . }
    public boolean isOnSale( )  { . . . }
    public void setOnSale(boolean onSale)  { . . . }
    public Float getDiscount( )  { . . . }
    public void setDiscount(Float discount)  { . . . }
    public String getSector( )  { . . . }
    public void setSector(String sector)  { . . . }
}
```

Now assume data has been partitioned as below:

```
CREATE TABLE t_product (
    id BIGINT,
    name VARCHAR(50),
PRIMARY KEY (id));
```

```
CREATE TABLE t_product_details (
    id BIGINT,
    price DOUBLE,
    on_sale BOOLEAN,
    discount_rate DOUBLE,
    sector VARCHAR(30),
PRIMARY KEY (id),
FOREIGN KEY (id) REFERENCES t_product(id));
```

Clearly a join on t_product.id and t_product_details.id is required in this case to properly populate all members in com.foo.Product. This is how one could have specified mappings for it:

```
<?xml version=“1.0” encoding=“UTF-8”?>
<!DOCTYPE project SYSTEM ‘cbproject-1.0.dtd’>
<project name=“default”>
  <class name=“com.foo.Product” primary-table=“t_product”>
    <join table=“t_product_details”>
      <join-key name=“id” column=“t_product_details.id”
      data-type=“bigint”/>
    </join>
    <member name=“id”>
      <attribute column=“t_product.id” data-type=“bigint” key=“true”/>
    </member>
    <member name=“name”>
      <attribute column=“t_product.name” data-type=“varchar”/>
    </member>
    <member name=“price”>
      <attribute column=“t_product_details.price”
      data-type=“double”/>
    </member>
    <member name=“onSale”>
      <attribute column=“t_product_details.on_sale” data-type=“bit”/>
    </member>
    <member name=“discount”>
      <attribute column=“t_product_details.discount_rate”
      data-type=“double”/>
    </member>
    <member name=“sector”>
      <attribute column=“t_product_details.sector”
      data-type=“varchar”/>
    </member>
  </class>
</project>
```

Note that once the join mappings have been specified, join table columns can be indiscriminately used within attribute member mappings.

There are cases where the join column does not contain an actual data value, but it is just a regular foreign key to the table being joined. Assume tables shown earlier have been redefined this way:

CREATE TABLE t_product (

id BIGINT,
name VARCHAR(50),
details_id BIGINT,

PRIMARY KEY (id),
FOREIGN KEY (details_id) REFERENCES t_product_details(id));

CREATE TABLE t_product_details (

id BIGINT,
price DOUBLE,
on_sale BIT,
discount_rate DOUBLE,
sector VARCHAR(30),

PRIMARY KEY (id),
FOREIGN KEY (id) REFERENCES t_product(id));

The above table definition assumes that a given product id may not always match the id value of the row in t_product_details that keeps its detail data. So, it defines a foreign key in t_product to refer to t_product_details.id. In this case, this is what mappings would look like:

```
<?xml version=“1.0” encoding=“UTF-8”?>
<!DOCTYPE project SYSTEM ‘cbproject-1.0.dtd’>
<project name=“default”>
  <class name=“com.foo.Product” primary-table=“t_product”>
    <join table=“t_product_details”>
      <join-key name=“@detailsId” column=“t_product_details.id”
      data-type=“bigint”/>
    </join>
    <member name=“id”>
      <attribute column=“t_product.id” data-type=“bigint” key=“true”/>
    </member>
    <member name=“name”>
      <attribute column=“t_product.name” data-type=“varchar”/>
    </member>
    <member name=“price”>
      <attribute column=“t_product_details.price”
      data-type=“double”/>
    </member>
    <member name=“onSale”>
      <attribute column=“t_product_details.on_sale” data-type=“bit”/>
    </member>
    <member name=“discount”>
      <attribute column=“t_product_details.discount_rate”
      data-type=“double”/>
    </member>
    <member name=“sector”>
      <attribute column=“t_product_details.sector”
      data-type=“varchar”/>
    </member>
    <member name=“@detailsId” access-mode=“none”>
      <attribute column=“t_product.details_id” data-type=“big-int”/>
    </member>
  </class>
</project>
```

Note that because that foreign key column is not a data mapped by an actual java attribute member, it is necessary to define a virtual attribute member mapping (i.e. access-mode set to none) to represent such column.

### 5.2. Generator Mapping

A generator is any mechanism that produces data values, which can be used to automatically populate table columns. Generators can be implemented through a database system facility, such as a database sequence or auto-increment data type, or through some custom generation technique where value generation is usually managed by applications. Generators are here classified in three major categories: sequence, table and embedded generators.

From the object-to-relational mapping standpoint, once the generator is setup, what matters the most is how to obtain the next value from that generator. And that is what needs to be specified by generator mappings. The XML definition of a generator mapping element is presented below:

| | <!ELEMENT generator (qualifier?)> |
|---|---|
| | (1) <!ATTLIST generator type (sequence \| table \| embedded) “sequence”> |
| | (2) <!ATTLIST generator mode (buffered \| unbuffered) “buffered”> |
| | (3) <!ATTLIST generator schema CDATA #IMPLIED> |
| | (4) <!ATTLIST generator table CDATA #IMPLIED> |
| | (5) <!ATTLIST generator column CDATA #REQUIRED> |
| | (6) <!ATTLIST generator data-type CDATA #IMPLIED> |
| | (7) <!ATTLIST generator db-type CDATA #IMPLIED> |
| | (8) <!ATTLIST generator size CDATA #IMPLIED> |
| | (9) <!ATTLIST generator searchable (true \| false) #IMPLIED> |
| | (10) <!ATTLIST generator signed (true \| false) #IMPLIED> |
| | (11) <!ATTLIST generator sql-map CDATA #IMPLIED> |
| (1) | type: specifies the generator type, which can be one of the following: |
| | sequence: indicates the generator value is obtained by selecting the next value of a |
| | database sequence generator. |
| | table: indicates the generator value is obtaining by a selection against an auxiliary |
| | table that keeps the last value. The table column that keeps this value needs to be |
| | updated every time it is accessed by the application. |
| | embedded: indicates the value will be generated as the object is being updated or |
| | inserted into the database (i.e. value generation is embedded within the sql |
| | statement that inserts or updates the object). That means the next generated value |
| | can only be obtained after the database operation is complete. |
| (2) | mode: indicates whether generated values should be obtained and buffered so they |
| | can be assigned to object attributes prior to inserting or updating those objects or |
| | not. Generators of type embedded can only function in unbuffered mode (due it is |
| | not possible to obtain the generated value prior to inserting or updating the object). |
| (3) | schema: an optional string that indicates the database schema containing the |
| | sequence or table used for generating values. |
| (4) | table: the database table the generated value must be selected from (may also apply |
| | to sequence generators as when a ‘dummy’ table is required for the selection). |
| (5) | column: a string containing the column expression used to retrieve the next |
| | generated value. |
| (6) | data-type: the data type used to load or store the value for this generator. Internally, |
| | this determines the jdbc type the system will use obtain or modify the data. |
| | Available data-types are: bit, tinyint, smallint, integer, bigint, real, float, double, |
| | numeric, decimal, char, varchar, longvarchar, date, time, timestamp, binary, |
| | varbinary, longvarbinary, java-object, distinct, struct, array, blob, clob, ref, null, |
| | other, calendar and its correspondence to Java types is the same as that given by the |
| | jdbc specification. |
| (7) | db-type: a string that describes how the given data type is represented in the target |
| | database. This is an optional attribute and its value can be obtained automatically by |
| | the system. |
| (8) | size: a string indicating the size (in length) used by the generator (or table) to store |
| | the data. This is an optional attribute and its value can be automatically inferred by |
| | the system. |
| (9) | searchable: indicates whether the target database supports search expressions on the |
| | generator column or not. This is an optional attribute and its value can be |
| | automatically inferred by the system. |
| (10) | signed: indicates whether the generator column maps to signed values or not. This |
| | is an optional attribute and its value can be automatically inferred by the system. |
| (11) | sql-map: the name of the sql map containing the sql used to obtain and maintain |
| | generated values. When not specified, it is assumed that sql should be dynamically |
| | generated at runtime. |

A generator mapping must be nested within an attribute mapping element, meaning that the value to be assigned to such attribute will be obtained from that generator. For example:

```
<member name=“id”>
            <attribute column=“t_product.id” data-type=“bigint”
key=“true”>
                                        <generator
type=“sequence”
      column=“product_id_sequence.nextval”
      table=“dual”
      data-type=“bigint”
    >
  </attribute>
</member>
```

### 5.2.1. Sequence Generators

A sequence generator is characterized by the use of a database sequence or similar facility capable of generating sequential (usually numeric) values. The advantage of using sequence generators is that since value generation is controlled by the database system, the application does not have to worry about issues such as concurrent access and transaction management on the generator facility. The one inconvenience though is that most database systems have their own proprietary syntax to create and manipulate database sequence generators. In general, the sql used to select the next sequence value has the following format:

select<column>[from [<schema>]<table>]

The contents of such mapping elements may vary according to the syntax used by the database system. The previous example specifices the mapping to obtain the next value for a sequence called product_id_sequence. It selects from a “dummy” table called dual so the sql expression is a valid one. This example is based on sequence usage for the Oracle database and the sql produced out of it should be equivalent to:

select product_id_sequence.nextval from dual

Once obtained, the sequence next value will be used to populate the attribute member id and, subsequently, its corresponding column t_product.id.

### 5.2.2. Table Generators

A table generator is implemented by using an auxiliary table where the next value to be generated is maintained. A simple implementation of a table generator uses one table for each value sequence that needs to be generated. Such table has only one column with one single row, which is previously populated with the initial value for the sequence. For example, assume table t_id_sequence is defined as below:

CREATE TABLE t_id_sequence (
next_id BIGINT NOT NULL
);

Now assume this table is populated with one single row:

t_id_sequence:
id
01

This is how mappings could be specified:

```
<member name=“id”>
  <attribute column=“t_product.id” data-type=“bigint” key=“true”>
    <generator type=“table”
      column=“next_id”
      table=“t_id_sequence”
      data-type=“bigint”
    >
  </attribute>
</member>
```

Apart from the generator type, which now is set to table, mappings are very close to those used for a sequence generator. The main difference though is that in a table generator, once the current value has been retrieved, the table must have its next value updated. Therefore, the sql produced by table generator mappings is a combination of a selection followed by an update. Here is an approximation of the sql that should be generated for the above mappings:

| | |
|---|---|
| 1. | id := select next_id from t_id_sequence |
| 2. | update t_id_sequence set next_id = next_id + 1 where |
| | next_id = :id |

First, at line 1, next_id value is selected from the generator table and assigned to the attribute value id (that is represented in pseudo sql code by the “:=” assignment symbol). Subsequently, at line 2, an update is performed against the generator table to increment the value of next_id. Note this update statement uses an optimistic locking where condition to make sure the update is successful for the id obtained from the selection. If that update fails (i.e. no records updated), it means another concurrent process already has allocated that same value and the selected value is out of date. The system then needs to repeat the selection in order to obtain a fresh value.

This approach may seem inconvenient when there are too many value sequences that need to be generated. For example, in an application with one hundred classes, each class using a different value sequence for its key attribute, there would be an additional one hundred generator tables.

A more sophisticated approach is to use one single table for a value sequence that need to be generated. For example, assume the generator table is defined as follows:

```
CREATE TABLE t_id_sequence (
    seq_name VARCHAR(30),
    next_id BIGINT NOT NULL,
PRIMARY KEY (class_name));
```

The difference here is that the generator table in this case has multiple rows, where each row is properly populated so it contains the next value of a given value sequence. For example, this is would be a possible way to have the generator table initially populated:

t_id_sequence:
seq_namenext_id

| | |
|---|---|
| ‘product_seq’ | 01 |
| ‘customer_seq’ | 01 |
| ‘supplier_seq’ | 01 |
| ‘order_seq’ | 01 |
| ‘line_item_seq’ | 01 |
| ‘address_seq’ | 01 |
| . . . . . . | |

But because now there's multiple rows, the sql to obtain the next value must include an additional where condition that indicates which sequence is the one the next value is being selected from. Generator mappings can deal with such scenarios by including a qualifier. A qualifier is a set of expressions (i.e. where conditions) to restrict the selection used to obtain the next generated value. It is particularly useful for mapping generator tables with multiple rows. Here's an example on how the above generator table could be mapped:

```
<member name=“id”>
  <attribute column=“t_product.id” data-type=“bigint” key=“true”>
    <generator type=“table” table=“t_id_sequence”
    column=“next_id” data-type=“bigint”>
      <qualifier>
        <expression lhs=“seq_name” operand“=”
        rhs=“‘product_seq’”/>
      </qualifier>
    </generator>
  </attribute>
</member>
```

The sql produced by such mappings should then be similar to:

```
1. id := select next_id from t_id_sequence where
seq_name = ‘product_seq’
2. update t_id_sequence
      set next_id = next_id + 1
      where next_id = :id and seq_name = ‘product_seq’
```

Note that qualifiers can have as many expressions as needed, and those can be combined using different logical conjunctions and condition levels.

### 5.2.3. Embedded Generators

Embedded generators are those where next values are assigned to columns only upon updating or inserting into the respective table. A common example of such generators is the use of auto increment or identity columns. Apart from that, any other mechanism where a value is automatically assigned to a column while an insert or update sql is being executed by the database system can be considered an embedded generator. Examples of such are the use of database triggers or database internal function calls. For example, the insert sql below could be considered an implementation of an embedded generator:

insert into t_product(id,name,price)
values( (select MAX(id)+1 from t_product) , ‘pencil’, ‘0.50’)

This sql shows how it generates values for column id as new rows are inserted into t_product. However, what needs to be specified when mapping an embedded generator is the sql used to obtain the last generated value so it can be assigned to the corresponding object. For the example above, one may assume the following sql would return the value just assigned to t_product.id:

select max(id) from t_product

But this is subject to failure as other concurrent processes may have inserted rows just before the selection above, which would then return the id value for the last inserted row rather than the value actually insert for the object in question. Some pessimistic locking techniques could be used here to solve this issue, but that would make the implementation less efficient and too resource intensive. That is why some database systems provide built-in support to identity or auto-increment columns. For example, this is how a table using an identity column would be declared in Sybase or MS-SQL server:

CREATE TABLE t_product (

id BIGINT IDENTITY,
name VARCHAR(50),
price DOUBLE,

PRIMARY KEY (id));

Such auto-increment column facilities are implemented in a way so that each process or application can obtain the last generated value within its own transaction scope. This allows the application to make sure the value obtained corresponds to the value assigned to the row it last inserted. A special sql expression can be usually executed for that purpose:

select @@identity

Note there is no from clause in the expression above. This is how mappings would look like for this sort of embedded generator:

<attribute column=“t_product.id” data-type=“bigint” key=“true”>

<generator type=“embedded” mode=“unbuffered”

column=“@@identity” data-type=“bigint”/>
</attribute>

Note that generator mappings are set to unbuffered mode, meaning that generated values cannot be obtained or buffered prior to inserting the row.

### 5.3. Transparent Identity Mapping

A common practice in object-oriented database application design is to let the persistence layer manage object identity in an automatic and transparent way. Object classes are defined without including members that hold identity (i.e. key) data. For example, let us take table t_product again:

CREATE TABLE t_product (

id BIGINT IDENTITY,
name VARCHAR(50),
price DOUBLE,

PRIMARY KEY (id));

Now assume com.foo.Product is defined this way:

```
/**
* Class com.foo.Product
*/
package com.foo;
    public class Product extends Object {
    public String getName( ) {...}
    public void setName(String name) {...}
    public Float getPrice( ) {...}
    public void setPrice(Float price) {...}
}
```

Note that differently from earlier examples, the class above does not include methods to modify or read its id. At the same time, this application expects the system to automatically populate the id column as the persistence layer stores new products. This can be achieved by defined a virtual attribute member mapping that contains a generator within it. For example:

```
<class name=“com.foo.Product” primary-table=“t_product”>
  <member name=“@id” access-mode=“none”>
    <attribute column=“t_product.id” data-type=“bigint” key=“true”>
      <generator type=“table” column=“next_id” table=“t_id_seq ”
      data-type=“bigint”
    >
  </member>
  <member name=“name”>
    <attribute column=“t_product.name” data-type=“varchar”/>
  </member>
  <member name=“price”>
    <attribute column=“t_product_details.price” data-type=“double”/>
  </member>
</class>
```

The virtual attribute member @id is set as the key for this class mapping. Note also that its mappings rely on a table generator to automatically populate the corresponding t_product.id column, although any other type of generator could have been used.

In case a generator it is not defined, the persistence layer APIs must provide ways to let the application specify a value for such transparent keys upon insertion. For the time being, let us just presume this is usually supported through the use of API methods that let the application pass in a key value along with the object to be inserted.

### 5.4. Composite Key Mapping

Composite keys in relational database parlance refer to table primary keys that are composed by more than one table column, as in the table definition below:

```
CREATE TABLE t_lineitem (
  order_id BIGINT,
  product_id BIGINT,
  quantity INTEGER,
  shipped BIT,
PRIMARY KEY (order_id,product_id),
FOREIGN KEY (order_id) REFERENCES t_order(id),
FOREIGN KEY (product_id) REFERENCES t_product(id));
```

Here the primary key is composed by columns order_id and product_id. Let us assume the corresponding java class com.foo.LineItem has been defined as:

/**
* Class com.foo.LineItem
*/
package com.foo;
public class LineItem extends Object {

public Long getOrderId( ) {...}
public void setOrderId(Long orderId) {...}
public Long getProductId( ) {...}
public void setProductId(Long productId) {...}
public Integer getQuantity( ) {...}
public void setQuantity(Integer qty) {...}
public boolean isShipped( ) {...}
public void setShipped(boolean shipped) {...}

}

Mapping the class above is pretty straightforward:

```
<class name=“com.foo.LineItem” primary-table=“t_lineitem”>
  <member name=“productId” key=“true”>
    <attribute column=“t_lineitem.product_id” data-type=“bigint”
    key=“true”/>
  </member>
  <member name=“orderId” key=“true”>
    <attribute column=“t_lineitem.order id” data-type=“bigint”
    key=“true”/>
  </member>
  <member name=“quantity”>
    <attribute column=“t_lineitem.quantity” data-type=“integer”/>
  </member>
  <member name=“shipped”>
    <attribute column=“t_lineitem.shipped” data-type=“bit”/>
  </member>
</class>
```

The only difference in this case is that both attribute member mappings orderId and productId have key set to true. Note the order attribute member mappings are declared is not important in this case, and it is not required to match the order primary key columns are specified in the underlying table.

The more meticulous reader may notice that the class above in fact models a sort of ternary relationship between orders, products and line item data. Some might prefer to say that is in fact a many-to-many relationship with attributes, which is evidenced by the fact that t_lineitem refers to the respective product and order by foreign key constraints. What really matters in this case is that the application needs to manipulate line item data directly, which is why a Java class has been defined for it. But at the same time, the application expects line item relationships to order and product to be automatically and transparently maintained by the persistence layer, and have com.foo.LineItem redefined this way:

/**
* Class com.foo.LineItem
*/
package com.foo;

public class LineItem extends Object {
public Integer getQuantity( ) {...}
public void setQuantity(Integer qty) {...}
public boolean isShipped( ) {...}
public void setShipped(boolean shipped) {...}
public Order getOrder( ) {...}
public void setOrder(Order order) {...}
public Product getProduct( ) {...}
public void setProduct(Product prod) {...}

}

Note that com.foo.LineItem now explicitly represents these relationships rather than dealing with its keys, which can no longer be directly manipulated. Mapping the class above is relatively simple:

```
<class name=“com.foo.LineItem” primary-table=“t_lineitem”>
  <member name=“@productId” access-mode=“none” key=“true”>
    <attribute column=“t_lineitem.product_id” data-type=“bigint”
    key=“true”/>
  </member>
  <member name=“@orderId” access-mode=“none” key=“true”>
    <attribute column=“t_lineitem.order_id” data-type=“bigint”
    key=“true”/>
  </member>
  <member name=“quantity”>
    <attribute column=“t_lineitem.quantity” data-type=“integer”/>
  </member>
  <member name=“shipped”>
    <attribute column=“t_lineitem.shipped” data-type=“bit”/>
  </member>
  <member name=“product”>
    <many-to-one
      target-class=“com.foo.Priduct”
      local-key-list=“@productId”
      target-key-list=“id”
    />
  </member>
  <member name=“order”>
    <many-to-one
      target-class=“com.foo.Order”
      local-key-list=“@orderId”
      target-key-list=“id”
    />
  </member>
</class>
```

A transparent identity is provided by the use of virtual attribute member mappings for the primary key columns, while relationship member mappings refer to those virtual attributes.

The present may be embodied in specific forms other than those particularly described above or illustrated by the appended drawings. Upon viewing the present application preferred embodiments and other descriptions herein of the present invention, variations and other implementations that do not depart from the spirit and scope of the present invention will be apparent to one of routine skill in this field. Such variations and other implementations are considered part of the present invention and within the scope of the appended claims. Accordingly, reference should be made to the appended claims, rather than to the forgoing specification and drawings, as indicating the scope of the present invention.

I claim:

1. A local or distributed computer system comprising a user interface, a working memory storage area and at least one device for permanently storing information, wherein a portion of said memory of said system is loaded with at least one portion of a computer software program containing logic for an object to object application or object to data source mapping system that utilizes a mapping workspace comprising at least two sets of meta data or having access to at least two sets of meta data, wherein one of the two sets provides the meta data for an object application logic program and the other set provides the meta data for at least one data source wherein computer the workspace utilizes computer implemented methods for creating or maintaining mapping for object to object, object to relational or object to XML and optional transparent batch persistence of a complex data object, a complex data object graph model, or a portion of a complex data object graph without the end user being required to understand the underlying object schemas, underlying data source schemas, or relationships and mismatches of both the underlying object schemas and underlying data source schemas.

2. A system according to claim 1, that does not require any modifications to an object model or the inclusion of any persistence byte code in the object model in order to provide persistence for all or a portion of the complex data object graph as a batch process.

3. A system according to claim 2, which provides persistence for a complex data object graph model on a distributed network environment.

4. A computer system and software implemented methods according to claim 1, further comprising computer implemented methods and software for automatically mapping objects to one or more object models, to one or more data sources, or both with an interface for setting mapping variables logic stringency for such automatic mapping and further including an optional interface for editing the resulting system generated mapping.

5. A system and software implemented methods according to claim 4, comprising the further step of providing such a system and software implemented methods that generate mapping output as one or more XML files that can be edited to fine tune, to change, or to add or delete objects, mapping relationships, or both.

6. A system and computer implemented software methods according to claim 1, further providing and utilizing an open and extensible mapping, business logic, and stored procedures repository structure that provides independence from how the mapping of object to object model, object to logic, or object to data source mapping metadata is stored or managed internally by the mapping system and allows standards compatibility with possible user customization and extensibility.

7. A system and computer implemented software methods according to claim 1, further providing a system and computer implemented software methods designed for static and deferred SQL map generation, such that static compilation of SQL logic at runtime permits a developer to interfere or manipulate the SQL used at runtime, while dynamic compilation permits the developer to avoid having to deal with details on how SQL is generated.

8. A system and computer implemented software methods of according to claim 1, further providing integration of the mapping system, including one or more of a mapping workspace system, automatic mapping system, open repository architecture and static or deferred mapping option, with one or more third party IDEs, case tools, or development platforms as an extension or replacement component for such IDEs, case tools, or development platforms by integration of some or all of the above functionality into the third party platform or development environment so that the developer can have access to the system and software implemented methods as an add on to their development environment and can be incorporated into their development process.

9. A system and computer implemented software methods of according to claim 1, further providing integration of the mapping system, including one or more of a mapping workspace system, automatic mapping system, open repository architecture and static or deferred mapping option, with systems and computer implemented logic for automatic, tunable, extensible, or managed code generation facilities to provide better code generation and manageability between the O/R, object to object application, or other object to data source mapping and subsequent code generation output in an automatic generation as a consequence of using the systems and computer implemented methods for one or more of a mapping workspace system, automatic mapping system, open repository architecture and static or deferred mapping option system.

10. A system and software implemented method according to claim 1, wherein the system and methods are adapted for using with a dot net type of system and software that utilizes dot net components as an alternative or replacement for the java software language logic based system.
